(19) United States
(12) Patent Application Publication
(10) Pub. No.: US 2025/0203489 A1
(43) Pub. Date: Jun. 19, 2025

(54) COMMUNICATION PROCESSING METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 19/066,524

(22) Filed: Feb. 28, 2025

Related U.S. Application Data
(63) Continuation of application No. PCT/CN2022/123820, filed on Oct. 8, 2022.

(51) Int. Cl. H04W 48/02

(52) U.S. Cl. CPC H04W 48/02

(57) ABSTRACT

A communication processing method a terminal device and a network device are provided. The method includes: a terminal device receiving first information, wherein the first information is related to cell access of a reduced capability terminal, the reduced capability terminal being a terminal device that supports a maximum bandwidth of less than 20 megahertz.

### CROSS-REFERENCE TO RELATED APPLICATION

This application is a continuation of International Patent Application No. PCT/CN2022/123820 filed on Oct. 8, 2022, the disclosure of which is hereby incorporated by reference in its entirety.

### BACKGROUND

The three major application scenarios of 5th Generation Mobile Communication Technology (5G) include Enhanced Mobile Broadband (eMBB), Massive Machine Type Communication (mMTC), and Ultra-Reliable and Low-Latency Communications (uRLLC). With the evolution of communication technology, terminal Internet of Thing (IoT) applications such as industrial wireless sensors, video surveillance, and wearable devices have put forward new requirements for 5G terminals, such as reduction of complexity and cost, size reduction, and lower power consumption. Therefore, the 3rd Generation Partnership Project (3GPP) introduced Reduced capability UE (RedCap UE) in Release 17 (R17) of the standardization process.

However, in order to further expand communication application scenarios, 3GPP Release 18 (R18) introduced a RedCap UE type with lower complexity and lower cost than ordinary RedCap UE. The introduction of this type of RedCap UE brings new challenges to the access control of the network.

### SUMMARY

Embodiments of the present disclosure relate to the technical field of mobile communication, and in particular, to a communication processing method, a terminal device, and a network device.

The embodiments of the present disclosure provide a communication processing method. The method includes the following operation. A terminal device receives the first information related to cell access of RedCap UE. The RedCap UE refers to UE that supports a maximum bandwidth of less than 20 MHz.

The embodiments of the present disclosure provide a terminal device, including a processor and a memory, wherein the memory is configured to store a computer program, and the processor is configured to invoke and execute the computer program stored in the memory to perform an operation of: receiving, by a terminal device, first information related to cell access of Reduced capability User Equipment (RedCap UE), wherein the RedCap UE refers to a terminal device that supports a maximum bandwidth of less than 20 MHz.

The embodiments of the present disclosure provide a network device, including a processor and a memory, wherein the memory is configured to store a computer program, and the processor is configured to invoke and execute the computer program stored in the memory to perform an operation of: transmitting, a network device, first information related to cell access of Reduced capability User Equipment (RedCap UE), wherein the RedCap UE refers to a terminal device that supports a maximum bandwidth of less than 20 MHz.

### BRIEF DESCRIPTION OF THE DRAWINGS

The accompanying drawings described herein are intended to provide a further understanding of the present disclosure and constitute a part of the present disclosure. The schematic embodiments of the present disclosure and the description thereof are intended to explain the present disclosure, and do not constitute an undue limitation of the present disclosure.

FIG. 1 is a schematic diagram of a communication architecture according to an embodiment of the present disclosure.

FIG. 2 is the first schematic flowchart of a communication processing method according to an embodiment of the present disclosure.

FIG. 3A is the second schematic flowchart of a communication processing method according to an embodiment of the present disclosure.

FIG. 3B is the third schematic flowchart of a communication processing method according to an embodiment of the present disclosure.

FIG. 3C is the fourth schematic flowchart of a communication processing method according to an embodiment of the present disclosure.

FIG. 4A is the fifth schematic flowchart of a communication processing method according to an embodiment of the present disclosure.

FIG. 4B is the sixth schematic flowchart of a communication processing method according to an embodiment of the present disclosure.

FIG. 4C is the seventh schematic flowchart of a communication processing method according to an embodiment of the present disclosure.

FIG. 5A is the eight schematic flowchart of a communication processing method according to an embodiment of the present disclosure.

FIG. 5B is the ninth schematic flowchart of a communication processing method according to an embodiment of the present disclosure.

FIG. 5C is the tenth schematic flowchart of a communication processing method according to an embodiment of the present disclosure.

FIG. 6A is the eleventh schematic flowchart of a communication processing method according to an embodiment of the present disclosure.

FIG. 6B is the twelfth schematic flowchart of a communication processing method according to an embodiment of the present disclosure.

FIG. 7 is the first schematic diagram of the structure of a communication processing apparatus according to an embodiment of the present disclosure.

FIG. 8 is the second schematic diagram of the structure of a communication processing apparatus according to an embodiment of the present disclosure.

FIG. 9 is a schematic structural diagram of a communication device according to an embodiment of the present disclosure.

FIG. 10 is a schematic structural diagram of a chip according to an embodiment of the present disclosure.

FIG. 11 is a schematic block diagram of a communication system according to an embodiment of the present disclosure.

### DETAILED DESCRIPTION

Hereinafter, the technical solutions in the embodiments of the present disclosure will be described with reference to the accompanying drawings in the embodiments of the present disclosure. It is apparent that the described embodiments are part of the embodiments of the present disclosure, but not all the embodiments. Based on the embodiments in the present disclosure, all other embodiments obtained by those skilled in the art without creative work fall within the scope of protection of the present disclosure.

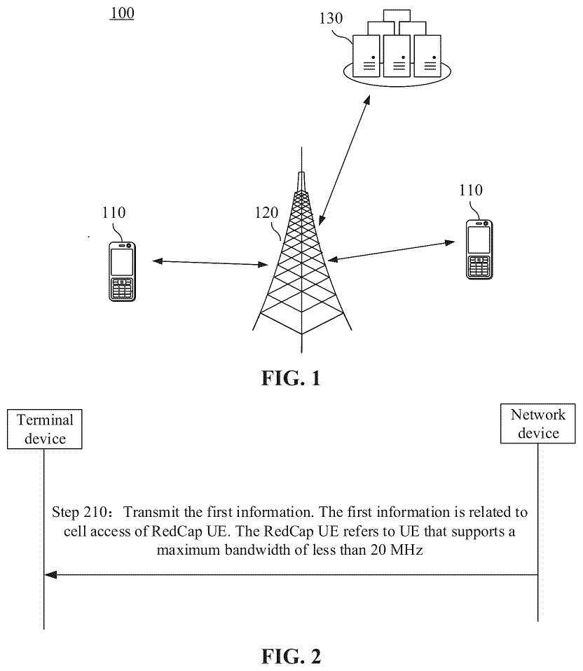

FIG. 1 is a schematic diagram of an application scenario according to an embodiment of the present disclosure.

As illustrated in FIG. 1, the communication system 100 may include terminal devices 110 and a network device 120. The network device 120 may communicate with the terminal device 110 through an air interface. Multi-service transmission is supported between the terminal device 110 and the network device 120.

It should be understood that the embodiments of the present disclosure are only illustrated with reference to the communication system 100, but the embodiments of the present disclosure are not limited thereto. That is, the technical solutions of the embodiment of the present disclosure may be applied to various communication systems, such as a Long Term Evolution (LTE) system, an LTE Time Division Duplex (TDD), a Universal Mobile Telecommunication System (UMTS), an Internet of Things (IoT) system, a Narrow Band Internet of Things (NB-IoT) system, an enhanced Machine-Type Communications (eMTC) system, a 5G communication system (also referred to as New Radio (NR) communication system), or future communication systems, etc.

In the communication system 100 illustrated in FIG. 1, the network device 120 may be an access network device that communicates with the terminal device 110. The access network device may provide communication coverage for a particular geographic area and may communicate with a terminal device 110 (e.g., a User Equipment (UE)) located within that coverage area.

The network device 120 may be an Evolutional Node B (eNB or eNodeB) in a Long Term Evolution (LTE) system, a Next Generation Radio Access Network (NG RAN) device, a base station (gNB) in an NR system, or a wireless controller in a Cloud Radio Access Network (CRAN), or the network device 120 may be a relay station, an access point, a vehicle-mounted device, a wearable device, a hub, a switch, a bridge, a router, or a network device in a future evolved Public Land Mobile Network (PLMN), etc.

The terminal device 110 may be any terminal device including, but not limited to, a terminal device connected with the network device 120 or other terminal devices by using wired or wireless connections.

For example, the terminal device 110 may refer to an access terminal, UE, a subscriber unit, a subscriber station, a mobile station, a mobile stage, a remote station, a remote terminal, a mobile device, a user terminal, a terminal, a wireless communication device, a user agent, or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with wireless communication functionality, a computing device or other processing device connected to a wireless modem, a vehicle-mounted device, a wearable device, a terminal device in a 5G network, or a terminal device in a future evolution network, or the like.

The terminal device 110 may be used for Device to Device (D2D) communication.

The wireless communication system 100 may further include a core network device 130 that communicates with the network device 120, and the core network device 130 may be a 5G Core (5GC) device, such as an Access and Mobility Management Function (AMF), an Authentication Server Function (AUSF), a User Plane Function (UPF), or a Session Management Function (SMF). Alternatively, the core network device 130 may also be an Evolved Packet Core (EPC) device of an LTE network, for example, a Session Management Function+Core Packet Gateway (SMF+PGW-C) device. It should be understood that the SMF+PGW-C can simultaneously implement functions that the SMF and PGW-C that can implement. In the process of network evolution, the core network device may be called by other names, or a new network entity may be formed by dividing the functions of the core network, which is not limited by the embodiments of the present disclosure.

The respective functional units in the communication system 100 may also establish a connection between each other through a next generation network (NG) interface to implement communication.

For example, the terminal device establishes an air interface connection with the access network device through the NR interface for transmitting user plane data and control plane signaling. The terminal device may establish a control plane signaling connection with the AMF through the NG interface 1 (N1 for short). The access network device, such as a next generation radio access base station (gNB), may establish a user plane data connection with the UPF through an NG interface 3 (N3 for short). The access network device may establish a control plane signaling connection with the AMF through the NG interface 2 (N2 for short). The UPF may establish a control plane signaling connection with the SMF through the NG interface 4 (N4 for short). The UPF may interact user plane data with the data network through the NG interface 6 (N6 for short). The AMF may establish a control plane signaling connection with the SMF through the NG interface 11 (N11 for short). The SMF may establish a control plane signaling connection with the PCF through the NG interface 7 (N7 for short).

FIG. 1 exemplarily illustrates one network device, one core network device, and two terminal devices. Alternatively, the wireless communication system 100 may include multiple network devices, and another number of terminal devices may be included within the coverage range of each network device, which is not limited by the embodiments of the present disclosure.

It should be noted that FIG. 1 only illustrates a system to which the present disclosure is applied in the form of an example, and of course, the methods in the embodiments of the present disclosure may also be applied to other systems. Furthermore, the terms “system” and “network” are often used interchangeably in the present disclosure. In the present disclosure, the term “and/or” is merely used for describing an association relationship of associated objects, which indicates that there may be three relationships. For example, A and/or B may represent that there are three situations: A exists alone, A and B exist simultaneously, or B exists alone. In addition, the character “/” in the present disclosure generally indicates that there is a “or” relationship between the associated objects. It should also be understood that the “indication” mentioned in the embodiments of the present disclosure may be a direct indication, an indirect indication, or represent an associated relationship. For example, A indicates B, which may mean that A directly indicates B, for example, B may be acquired by A. It may also mean that A indicates B indirectly, for example, A indicates C, and B may be acquired through C. It may also represent that there is an association relationship between A and B. It should also be understood that the term “correspondence” mentioned in the embodiments of the present disclosure may represent that there is a direct correspondence or indirect correspondence between the two objects, may represent that there is an associated relationship between the two objects, or may represent a relationship between indicating and being instructed, configuring and being configured, or the like. It should also be understood that the “predefined” or “predefined rule” mentioned in the embodiments of the present disclosure may be realized by storing corresponding codes, tables, or other methods that may be used to indicate relevant information in advance in devices (including, for example, the terminal device and the network device), and specific implementations are not limited in the present disclosure. For example, “predefined” may refer to “defined” in the protocol. It should also be understood that in the embodiments of the present disclosure, the term “protocol” may refer to a standard protocol in the field of communication, may include, for example, an LTE protocol, an NR protocol, and related protocols applied to future communication systems, which is not limited in the present disclosure.

In order to facilitate understanding of the technical solutions of the embodiments of the present disclosure, the related technologies of the embodiments of the present disclosure will be described below, and the related technologies below may be arbitrarily combined with the technical solutions of the embodiments of the present disclosure as optional solutions, and all of them belong to the scope of protection of the embodiments of the present disclosure.

3GPP R17 introduces RedCap UE for NR system. Currently, RedCap UE mainly is used in three scenarios.

1. Industrial Wireless Sensors. Compared with URLLC, the Industrial Wireless Sensors have relatively low requirements for latency and reliability, as well as lower requirements for cost and power consumption. The main requirements and features of the Industrial Wireless Sensors include: communication reliability of 99.99%, end-to-end delay of <100 ms, reference data rate of less than 2 Mbps and mainly for uplink services, equipment stationary, and battery life of several years. In addition, for wireless sensors used in security related aspects, the delay requirement is lower, for example, the delay requirement is 5 to 10 ms.

2. Video surveillance. Video surveillance is mainly used in smart cities, industrial factories, etc. Data collection and processing in smart cities may facilitate more effective monitoring and control of urban resources and provide more effective services to urban residents. Video surveillance mainly focuses on uplink services. Other main requirements include: the reference rate of ordinary resolution video is 2˜4 Mbps, the delay is less than 500 ms, and the communication reliability is 99%˜99.9%. The rate requirement for HD video is 7.5˜25 Mbps

3. Wearables. The Wearables include smart watches, smart bracelets, electronic health devices and some medical monitoring devices. One common feature of these devices is the small size of the device. Key indicator requirements for wearables include: downlink and uplink reference rates are 5˜50 Mbps and 2˜5 Mbps respectively, peak downlink and uplink rates are 150 Mbps and 50 Mbps respectively, requiring the battery to work for several days or even 1 to 2 weeks.

In order to enable a RedCap UE and a normal terminal (i.e., a non-RedCap UE) to share the same Synchronization Signal and PBCH block (SSB), a control resource set, and a System Information Blocks (SIB), the maximum bandwidth of the RedCap UE in a low band (i.e., a FR1 band) may be reduced from 100 MHz to 20 MHz. At the same time, the maximum bandwidth of the RedCap UE in the high band (i.e., a FR2 band) may be reduced to 100 MHz. The maximum bandwidth here includes Radio Frequency (RF) bandwidth and baseband bandwidth.

The cell access control mechanism is described below.

In the NR system, the network device may carry cellBarred information in a Master Information Block (MIB). The cellBarred may be used to indicate whether all terminals are barred from accessing the current cell. If cellBarred indicates being barred, then the terminal device needs to perform cell reselection. If cellBarred indicates not barred, the terminal device may access the current cell. The MIB may also carry intra frequency reselection indication information (intraFreqReselection). The intraFreqReselection may indicate whether all UE are allowed to perform cell reselection in a neighboring cell in the intra frequency.

In addition, for the RedCap UE, R17 introduces cell access prohibition information of the RedCap UE supporting one reception link (RX) (cellBarredRedCap1Rx), cell access prohibition information of the RedCap UE supporting two RXs (cellBarredRedCap2Rx), and cell access prohibition information of the RedCap UE supporting half-duplex (halfDuplexRedCapAllowed).

3GPP R18 introduces a RedCap UE type with lower complexity and lower cost for RedCap UE supporting the FR1 band. Specifically, the bandwidth supported by the newly introduced RedCap UE with lower complexity and lower cost may be less than the maximum bandwidth supported by the current RedCap UE, for example, the maximum bandwidth supported by the newly introduced RedCap UE type may be 5 MHz.

It may be understood that after the introduction of the RedCap UE type with lower complexity and lower cost, there is currently no clear method for the network to perform access control on the new RedCap UE to achieve more refined terminal access control.

In order to facilitate understanding of the technical solutions of the embodiments of the present disclosure, the technical solutions of the present disclosure will be described in detail below with reference to specific embodiments. The above related technologies may be arbitrarily combined with the technical solutions of the embodiments of the present disclosure as optional solutions, and all of them belong to the scope of protection of the embodiments of the present disclosure. Embodiments of the present disclosure include at least some of the following.

Referring to FIG. 2, the communication processing method according to the embodiment of the present disclosure may include the following operation.

In operation 210, a network device transmits the first information, and a terminal device receives the first information. The first information is related to cell access of RedCap UE. The RedCap UE refers to a terminal device that supports a maximum bandwidth of less than 20 MHz.

The RedCap UE mentioned in the embodiments of the present disclosure may be RedCap UE with lower complexity and/or lower cost than the RedCap UE introduced in R17.

In R17, the maximum bandwidth supported by the RedCap UE in the FR1 band is 20 MHz, and the maximum bandwidth supported by the RedCap UE in the FR2 band is 100 MHz. The RedCap UE mentioned in the embodiments of the present disclosure may be RedCap UE that supports a maximum bandwidth of less than 20 MHz.

For example, the maximum bandwidth supported by the RedCap UE is 5 MHZ, or the maximum baseband bandwidth supported by the RedCap UE is 5 MHZ, and the RF bandwidth remains unchanged, or the maximum bandwidth supported by the RedCap UE is 5 MHz only in a physical shared channel (which may include a physical uplink/downlink shared channel, that is, a PUSCH/PDSCH).

It should be noted that the maximum bandwidth supported by the above RedCap UE may be for the FR1 band. In the embodiments of the present disclosure, the RedCap UE may be referred to as an Enhanced RedCap UE (eRedCap UE).

Alternatively, the network device may broadcast the above first information in the communication coverage of the network device. That is, the first information may be broadcast information.

Alternatively, the first information may be a System Information Block (SIB), for example, the first information may be at least one of SIB1 to SIB14, and the embodiment of the present disclosure does not limit the specific SIB type.

It may be understood that the network device may configure the first information related to cell access unique to the this type of RedCap UE for the eRedCap UE, and broadcast the first information to the terminal device. Accordingly, after receiving the first information, the terminal device may perform cell access according to the first information.

It may be seen that the eRedCap UE may be independently controlled to perform cell access by configuring information related to cell access unique to the eRedCap UE, thereby realizing more flexible and refined cell access. For example, when network congestion occurs, the network may still expect some terminals to be able to access. In this case, the network may broadcast the first information unique to the eRedCap UE, and only the eRedCap UE whose maximum bandwidth is less than 20 MHz can access the network, thereby realizing more refined access control.

Alternatively, the first information may be used to indicate at least one of: whether the eRedCap UE is prohibited from accessing the first cell, whether the eRedCap UE is allowed to perform intra frequency cell reselection, or at least one piece of second information. The at least one piece of second information corresponding to at least one frequency point, and each piece of second information is used to indicate whether the eRedCap UE is allowed to access a frequency point corresponding to the current second information.

In the embodiments of the present disclosure, the first information may include a cell access indication parameter (cellBarred), for example, a parameter “cellBarredRedCapEnhanced”, separately configured for the eRedCap UE. The parameter indicates whether the eRedCap UE is prohibited from accessing the first cell, that is, the parameter indicates whether the first cell supports the eRedCap UE. Here, the first cell may be a cell corresponding to a network device that transmits system information, and may be a serving cell or a to-be-accessed target cell.

In the embodiments of the present disclosure, the first information may include an Intra Frequency Reselection Indications (IFRI) parameter separately configured for the eRedCap UE, for example, the first information may include a parameter “intraFreqReselectionRedCapEnhanced”. The first information indicates whether the eRedCap UE is allowed to perform intra frequency cell reselection by the parameter.

It should be noted that, when the network device does not configure the target parameter in the first information, the eRedCap UE may consider that the eRedCap UE is prohibited from accessing the first cell. The target parameter may be a parameter for indicating whether the eRedCap UE is allowed to perform intra frequency cell reselection, such as the parameter “intraFreqReselectionRedCapEnhanced”.

In the embodiments of the present disclosure, the first information may include at least one piece of second information. The at least one piece of second information may be understood as configuration information separately for the eRedCap UE, and simply put, the second information may be information on whether the neighboring cell frequency point (that is, the inter frequency point) supports the eRedCap UE. It should be understood that the number of neighboring cell frequency point may be one or more, and each frequency point may be configured with one piece of second information. Each piece of second information may indicate whether the eRedCap UE is allowed to access the frequency point corresponding to the current second information.

Alternatively, the second information may be represented by “redCapAccessAllowedEnhanced”.

Exemplarily, the network device may configure a list of inter frequency points, and the network device may configure a parameter “redCapAccessAllowedEnhanced” for each frequency point in the list, which indicates whether the current frequency point supports the eRedCap UE.

The first information may indicate any one of the above three items alone.

Alternatively, in the first information, a parameter for indicating whether the eRedCap UE is prohibited from accessing the first cell, a parameter for indicating whether the eRedCap UE is allowed to perform the intra frequency cell reselection, and the at least one piece of second information may be carried by the same SIB or different SIBs. Exemplarily, the parameter for indicating whether the eRedCap UE is prohibited from accessing the first cell and the parameter for indicating whether the eRedCap UE is allowed to perform intra frequency cell reselection may be carried by SIB1 or another SIB, and at least one piece of second information may be carried by SIB4 or another SIB, which is not limited by the embodiment of the present disclosure.

It may be seen that different access processes of the eRedCap UE may be controlled respectively by configuring access prohibition information, intra frequency reselection indication information, and information related to access in inter frequency points unique to the eRedCap UE, thereby further improving the flexibility of cell access control.

Alternatively, in some embodiments, the first information may include multiple pieces of first sub-information, and the first sub-information is related to the number of reception links (RX) supported by the terminal.

Each piece of first sub-information is used to indicate whether UE, which supports a number N of reception links of the eRedCap UE is prohibited from accessing the first cell. N is greater than or equal to 1, and different pieces of first sub-information correspond to different numbers N of reception links.

It may be understood that eRedCap UEs may be further distinguished according to the number of reception links supported by the UE. Different pieces of first sub-information are used to respectively indicate whether UE, which supports different numbers of reception links, of the eRedCap UE is prohibited from accessing the first cell, that is, different pieces of first sub-information are used to indicate whether the first cell supports eRedCap UE with different numbers of RX.

Alternatively, the first information may be distinguished according to one RX and two RXs. Specifically, “cellBarredRedCap1RxEnhanced” may indicate whether the eRedCap UE supporting one RX is prohibited from accessing t the first cell, and “cellBarredRedCap2RxEnhanced” may indicate whether the eRedCap UE supporting two RXs is prohibited from accessing the first cell. It should be noted that the first information may also be distinguished according to eRedCap UE with a greater number of reception links, and this is not enumerated one by one in the embodiments of the present disclosure.

Exemplarily, if “cellBarredRedCap1RxEnhanced” indicates “barred”, it may be considered that the current first cell does not support all eRedCap UE with one RX, that is, all eRedCap UE with one RX is prohibited from accessing. If “cellBarredRedCap1RxEnhanced” indicates “not barred”, it may be considered that the current first cell supports all eRedCap UE with one RX, that is, all eRedCap UE with one RX is allowed to access.

Alternatively, in another embodiment, the first information may include the second sub-information and/or the third sub-information. The second sub-information and/or the third sub-information may be related to a duplex capability supported by the terminal device.

The second sub-information may be used to indicate whether the UE, which supports half-duplex, of the eRedCap UE is prohibited from accessing the first cell, and the third sub-information may be used to indicate whether the UE, which supports full-duplex, of the eRedCap UE is prohibited from accessing the first cell.

That is, the eRedCap UE may be further distinguished according to the duplex capability supported by the terminal device. Whether the eRedCap UE supporting half-duplex is prohibited from accessing the first cell may be indicated by the second sub-information, and whether the eRedCap UE supporting full-duplex is prohibited from accessing the first cell may be indicated by the third sub-information.

It may be seen that, in the communication processing method provided by the embodiments of the present disclosure, cell access prohibition information may be separately configured for eRedCap UEs having different capabilities, so as to facilitate cell access control for some terminals of the eRedCap UE, thereby further reducing the granularity of the cell access control and improving the flexibility of the cell access control.

Hereinafter, a specific method in which the eRedCap UE determines whether the eRedCap UE is prohibited from accessing the first cell will be described in detail.

In an embodiment of the present disclosure, the eRedCap UE may separately determine whether the eRedCap UE is prohibited from accessing the first cell according to the first information. Alternatively, after receiving the first information, the eRedCap UE may perform at least one of: determining whether the eRedCap UE is prohibited from accessing the first cell according to the first information; determining whether the eRedCap UE is prohibited from accessing the first cell according to the number of reception links supported by the eRedCap UE and multiple pieces of first sub-information; or determining whether the eRedCap UE is prohibited from accessing the first cell according to the second sub-information and/or the third sub-information and the duplex capability supported by the eRedCap UE.

In a possible implementation, when the first information is used as separate indication information, the eRedCap UE may directly determine whether the eRedCap UE is prohibited from accessing the first cell according to the indication content of the first information.

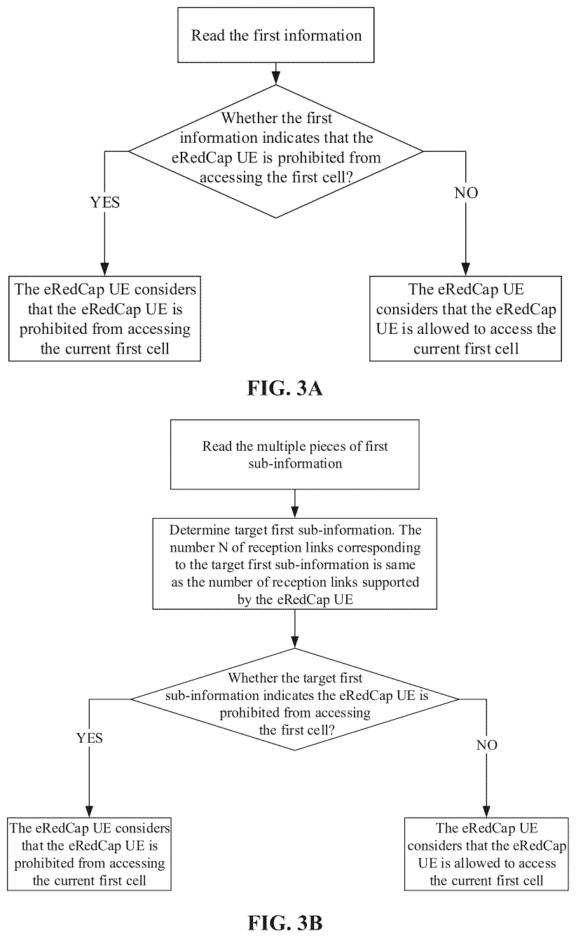

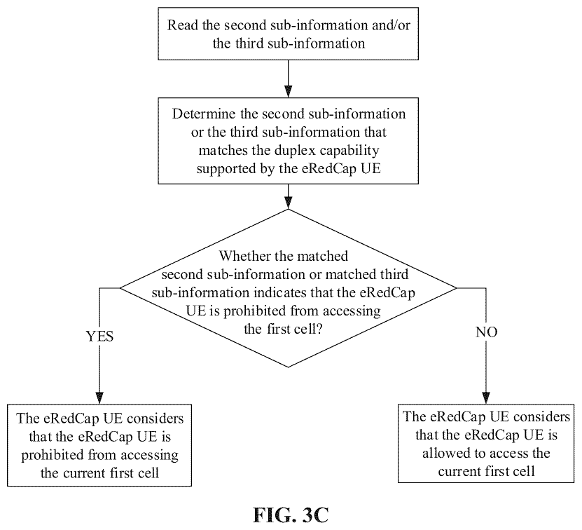

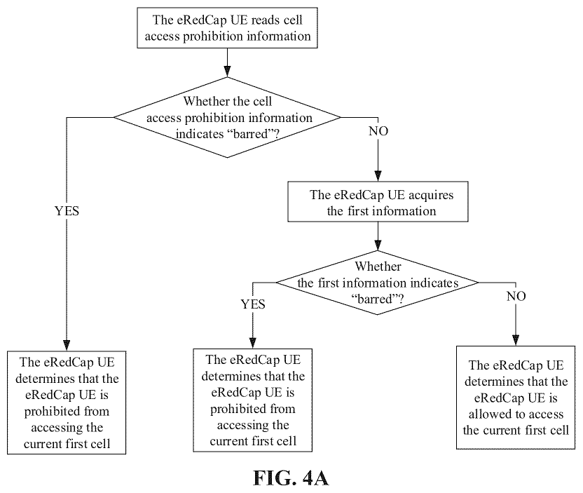

In this implementation, referring to the flowchart illustrated in FIG. 3A, the eRedCap UE may determine whether the eRedCap UE is prohibited from accessing the first cell according to the following manner.

The first operation is reading the first information.

The second operation is determining whether the eRedCap UE is prohibited from accessing the first cell according to the first information.

The operation that the eRedCap UE determines whether the eRedCap UE is prohibited from accessing the first cell according to the first information may be implemented by the following manner.

Whether the first information indicates that the eRedCap UE is prohibited from accessing the first cell is judged.

If the first information indicates that the eRedCap UE is prohibited from accessing the first cell, the eRedCap UE considers that the eRedCap UE is prohibited from accessing the current first cell. If the first information indicates that the eRedCap UE is not prohibited from accessing the first cell, the eRedCap UE considers that the eRedCap UE is allowed to access the current first cell.

It should be understood that the first information may indicate “barred” or “not barred”. After receiving the SIB, the eRedCap UE may read the first information “cellBarredRedCapEnhanced” in the SIB. When the first information indicates “barred”, it may be considered that all eRedCap UE is prohibited from accessing the first cell, and when the first information indicates “not barred”, it may be considered that all eRedCap UE is allowed to access the first cell.

In another possible implementation, when the first information includes multiple pieces of first sub-information, the eRedCap UE may determine whether the eRedCap UE is prohibited from accessing the first cell according to the number of reception links supported by the eRedCap UE and the multiple pieces of first sub-information.

In this implementation, referring to the flowchart illustrated in FIG. 3B, the eRedCap UE may determine whether the eRedCap UE is prohibited from accessing the first cell by the following manner.

The first operation is reading the multiple pieces of first sub-information.

The second operation is determining whether the eRedCap UE is prohibited from accessing the first cell according to the number of reception links supported by the eRedCap UE and the multiple pieces of first sub-information.

The operation that the eRedCap UE determines whether the eRedCap UE is prohibited from accessing the first cell according to the number of reception links supported by the eRedCap UE and the multiple pieces of first sub-information may be implemented by the following manner.

Target first sub-information is determined. The number N of reception links corresponding to the target first sub-information is same as the number of reception links supported by the eRedCap UE.

If the target first sub-information indicates that the eRedCap UE is prohibited from accessing the first cell, it is determined that the eRedCap UE is prohibited from accessing the first cell.

If the target first sub-information indicates that the eRedCap UE is not prohibited from accessing the first cell, it is determined that the eRedCap UE is allowed to access the first cell.

It may be understood that the eRedCap UE may firstly acquire the first sub-information matching the number of RXs supported by the eRedCap UE from the multiple pieces of first sub-information to obtain the target first sub-information. Next, the eRedCap UE may determine whether the eRedCap UE is allowed to access the first cell according to the specific indication content of the target first sub-information, that is, whether the first cell supports the eRedCap UE having the number of RXs. Specifically, if the target first sub-information indicates “barred”, the eRedCap UE may consider that the eRedCap UE is prohibited from accessing the first cell, and if the target first sub-information indicates “not barred”, the eRedCap UE may consider that the eRedCap UE is allowed to access the first cell.

Exemplarily, in a scenario in which the network device indicates by “cellBarredRedCap1RxEnhanced” whether the eRedCap UE supporting one RX is prohibited from accessing the first cell, and the network device indicates by “cellBarredRedCap2RxEnhanced” whether the eRedCap UE supporting two RXs is prohibited from accessing the first cell, after receiving the SIB1, the eRedCap UE may read “cellBarredRedCap1RxEnhanced” or “cellBarredRedCap2RxEnhanced” in the SIB1 according to the number of RXs supported by the eRedCap UE.

If the eRedCap UE supports one RX, the eRedCap UE may read “cellBarredRedCap1RxEnhanced” in SIB1. When “cellBarredRedCap1RxEnhanced” indicates “barred”, the eRedCap UE may consider that the eRedCap UE is prohibited from accessing the current first cell. When “cellBarredRedCap1RxEnhanced” indicates “not barred”, the eRedCap UE may consider that the eRedCap UE is allowed to access the current first cell. Accordingly, if the eRedCap UE supports two the eRedCap UE may read RXs, “cellBarredRedCap2RxEnhanced” in SIB1. When “cellBarredRedCap2RxEnhanced” indicates “barred”, the eRedCap UE may consider that the eRedCap UE is prohibited from accessing the current first cell. When “cellBarredRedCap2RxEnhanced” indicates “not barred”, the eRedCap UE may consider that the eRedCap UE is allowed to access the current first cell.

In yet another possible implementation, when the first information includes the second sub-information and/or the third sub-information, the eRedCap UE may determine whether the eRedCap UE is prohibited from accessing the first cell according to the second sub-information and/or the third sub-information and the duplex capability supported by the eRedCap UE.

In this implementation, referring to the flowchart illustrated in FIG. 3C, the eRedCap UE may determine whether the eRedCap UE is prohibited from accessing the first cell by the following manner.

The first operation is reading the second sub-information and/or the third sub-information.

The second operation is determining whether the eRedCap UE is prohibited from accessing the first cell according to the second sub-information and/or the third sub-information and the duplex capability supported by the eRedCap UE.

The operation that the eRedCap UE determines whether the eRedCap UE is prohibited from accessing the first cell according to the second sub-information and/or the third sub-information and the duplex capability supported by the eRedCap UE may be implemented by the following manner.

The second sub-information or the third sub-information that matches the duplex capability supported by the eRedCap UE is determined.

If the matched second sub-information or matched third sub-information indicates that the eRedCap UE is prohibited from accessing the first cell, it is determined that the eRedCap UE is prohibited from accessing the first cell.

If the matched second sub-information or matched third sub-information indicates that the eRedCap UE is not prohibited from accessing the first cell, it is determined that the eRedCap UE is allowed to access the first cell.

That is, the eRedCap UE may firstly acquire the sub-information matched the duplex capability supported by the eRedCap UE from the second sub-information and/or the third sub-information. Next, the eRedCap UE may determine whether the eRedCap UE is allowed to access the first cell according to the specific indication content of the matched sub-information (the second sub-information or the third sub-information). Specifically, if the matched sub-information indicates “barred”, the eRedCap UE may consider that the eRedCap UE is prohibited from accessing the first cell, and if the matched sub-information indicates “not barred”, the eRedCap UE may consider that the eRedCap UE is allowed to access the first cell.

Exemplarily, in a case that the eRedCap UE is a half-duplex terminal, the eRedCap UE may select the second sub-information to perform cell access control. If the second sub-information indicates “barred”, the eRedCap UE may consider that the eRedCap UE supporting half-duplex is prohibited from accessing the first cell, that is, the first cell does not support the eRedCap UE supporting half-duplex. If the second sub-information indicates “not barred”, the eRedCap UE may consider that the eRedCap UE supporting half-duplex is allowed to access the first cell, that is, the first cell supports the eRedCap UE supporting half-duplex. In a case that the eRedCap UE is a full-duplex terminal, the eRedCap UE may select the third sub-information to perform cell access control. If the third sub-information indicates “barred”, the eRedCap UE may consider that the eRedCap UE supporting full-duplex is prohibited from accessing the first cell, that is, the first cell does not support the eRedCap UE supporting full-duplex. If the third sub-information indicates “not barred”, the eRedCap UE may consider that the eRedCap UE supporting full-duplex is allowed to access the first cell, that is, the first cell supports the eRedCap UE supporting full-duplex.

In summary, in the communication processing method provided by the embodiment of the present disclosure, the first information and the sub-information included in the first information configured for the eRedCap UE may operate independently. That is, the eRedCap UE may directly determine whether the eRedCap UE is prohibited from accessing the first cell according to the first information or sub-information included in the first information, and the indication method is simple and flexible.

In another embodiment of the present disclosure, the eRedCap UE may determine whether the eRedCap UE is prohibited from accessing the first cell together with the first information in combination with the cell access prohibition information (i.e., cellbarred).

Alternatively, the communication processing method provided by the embodiment of the present disclosure may further include the following operation.

The network device transmits the cell access prohibition information, and the terminal device receives the cell access prohibition information.

The cell access prohibition information may be used to indicate, together with the first information, whether the eRedCap UE is prohibited from accessing the first cell.

Alternatively, the cell access prohibition information is used to indicate, together with the multiple pieces of first sub-information, whether the eRedCap UE is prohibited from accessing the first cell.

Alternatively, the cell access prohibition information is used to indicate, together with the second sub-information and/or the third sub-information, whether the eRedCap UE is prohibited from accessing the first cell.

Alternatively, the cell access prohibition information may be carried through a Master Information Block (MIB).

It should be understood that the MIB typically carries general information of the terminal device. The cell access prohibition information carried in the MIB may be understood to be for all terminal devices in the network.

In a possible implementation, when the first information is separate indication information, the cell access prohibition information may indicate, together with the first information, whether the eRedCap UE is prohibited from accessing the first cell.

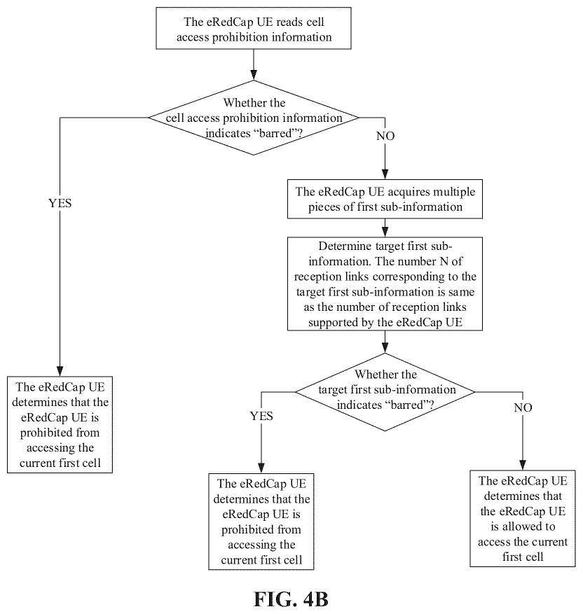

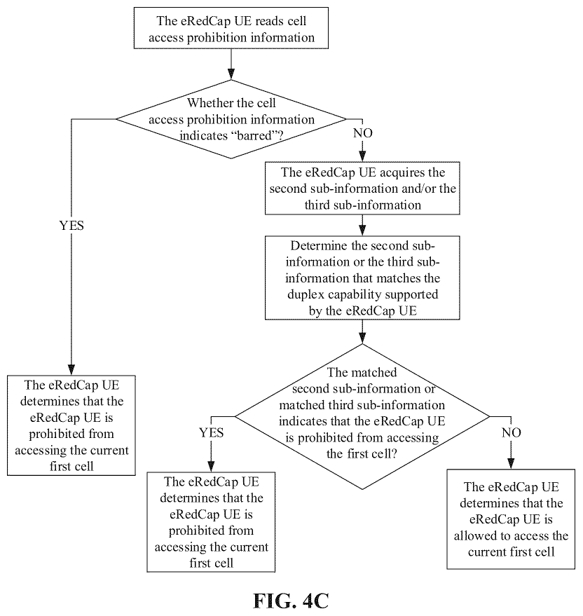

In this implementation, referring to the flowchart illustrated in FIG. 4A, the eRedCap UE may determine whether the eRedCap UE is prohibited from accessing the first cell by the following manner.

In the first operation, the eRedCap UE reads cell access prohibition information.

In the second operation, the eRedCap UE judges whether the cell access prohibition information indicates “barred”.

In the third operation, if the cell access prohibition information indicates that the eRedCap UE is prohibited from accessing the first cell (i.e., indicates “barred”), the eRedCap UE determines that the eRedCap UE is prohibited from accessing the current first cell.

In the fourth operation, if the cell access prohibition information indicates that the eRedCap UE is not prohibited from accessing the first cell (i.e., indicates “not barred” is), the eRedCap UE acquires the first information, so as to determine whether the eRedCap UE is prohibited from accessing the first cell according to the first information in the SIB.

In the fifth operation, the eRedCap UE determines whether the eRedCap UE is prohibited from accessing the first cell according to the first information.

Alternatively, the operation that the eRedCap UE determines whether the eRedCap UE is prohibited from accessing the first cell according to the first information may be implemented by the following manner.

If the first information indicates “barred”, the eRedCap UE may determine that the eRedCap UE is prohibited from accessing the current first cell. If the first information indicates “not barred”, the eRedCap UE may determine that the eRedCap UE is allowed to access the current first cell.

In another possible implementation, when the first information includes multiple pieces of first sub-information, the cell access prohibition information may indicate, together with the multiple pieces of first sub-information, whether the eRedCap UE is prohibited from accessing the first cell.

In this implementation, referring to the flowchart illustrated in FIG. 4B, the eRedCap UE may determine whether the eRedCap UE is prohibited from accessing the first cell according to the following manner.

In the first operation, the eRedCap UE reads cell access prohibition information.

In the second operation, the eRedCap UE determines whether the cell access prohibition information indicates “barred”.

In the third operation, if the cell access prohibition information indicates that the eRedCap UE is prohibited from accessing the first cell (i.e., indicates “barred”), the eRedCap UE determines that the eRedCap UE is prohibited from accessing the first cell.

In the fourth operation, if the cell access prohibition information indicates that the eRedCap UE is not prohibited from accessing the first cell (i.e., indicates “not barred”), the eRedCap UE acquires the multiple pieces of first sub-information, so as to determine whether the eRedCap UE is prohibited from accessing the first cell according to the multiple pieces of first sub-information.

In the fifth operation, the eRedCap UE may determine whether the eRedCap UE is prohibited from accessing the first cell according to the number of reception links supported by the eRedCap UE and the multiple pieces of first sub-information.

Alternatively, the operation that the eRedCap UE may determine whether the eRedCap UE is prohibited from accessing the first cell according to the number of reception links supported by the eRedCap UE and the multiple pieces of first sub-information may be implemented by the following manner.

Target first sub-information is determined. The number N of reception links corresponding to the target first sub-information is the same as the number of reception links supported by the eRedCap UE.

If the target first sub-information indicates that the eRedCap UE is prohibited from accessing the first cell, it is determined that the eRedCap UE is prohibited from accessing the first cell.

If the target first sub-information indicates that the eRedCap UE is not prohibited from accessing the first cell, it is determined that the eRedCap UE is allowed to access the first cell.

In yet another possible implementation, when the first information includes the second sub-information and/or the third sub-information, the cell access prohibition information may indicate whether the eRedCap UE is prohibited from accessing the first cell together with the second sub-information and/or the third sub-information.

In this implementation, referring to the flowchart illustrated in FIG. 4C, the eRedCap UE may determine whether the eRedCap UE is prohibited from accessing the first cell according to the following manner.

In the first operation, the eRedCap UE reads cell access prohibition information.

In the second operation, the eRedCap UE determines whether the cell access prohibition information indicates “barred”.

In the third operation, if the cell access prohibition information indicates that the eRedCap UE is prohibited from accessing the first cell (i.e., indicates “barred”), the eRedCap UE determines that the eRedCap UE is prohibited from accessing the first cell.

In the fourth operation, if the cell access prohibition information indicates that the eRedCap UE is not prohibited from accessing the first cell (i.e., indicates “not barred”), the eRedCap UE acquires the second sub-information and/or the third sub-information.

In the fifth operation, the eRedCap UE may determine whether the eRedCap UE is prohibited from accessing the first cell according to the second sub-information and/or the third sub-information and the duplex capability supported by the eRedCap UE.

Alternatively, the operation of determining whether the eRedCap UE is prohibited from accessing the first cell according to the second sub-information and/or the third sub-information and the duplex capability supported by the eRedCap UE may be implemented by the following manner.

The second sub-information or the third sub-information that matches the duplex capability supported by the eRedCap UE is determined.

If the matched second sub-information or matched third sub-information indicates that the eRedCap UE is prohibited from accessing the first cell, it is determined that the eRedCap UE is prohibited from accessing the first cell.

If the matched second sub-information or matched third sub-information indicates that the eRedCap UE is not prohibited from accessing the first cell, it is determined that the eRedCap UE is allowed to access the first cell.

In summary, in the communication processing method provided by the embodiment of the present disclosure, the cell access state of the eRedCap UE is indicated by the first information and the multiple pieces of sub-information configured for the eRedCap UE in combination with the cell access prohibition information (“cell barred”) in the MIB. The newly introduced cell access control information may be compatible with the existing cell access parameters, and the flexibility of network device configuration may be improved at the same time.

In still another embodiment of the present disclosure, the eRedCap UE may determine whether the eRedCap UE is prohibited from accessing the first cell according to the cell access prohibition information, the related access information for the normal RedCap UE, and the first information.

Alternatively, the network device may transmit multiple pieces of third information to the terminal device. Each piece of third information is used to indicate whether UE, that supports a number M of reception links, of target UE is prohibited from accessing the first cell, M is greater than or equal to 1, and different pieces of third information correspond to different numbers M of reception links. The target UE refers to UE that supports a maximum bandwidth of less than or equal to 20 MHz.

It may be understood that the target UE may be a normal RedCap UE introduced in R17. The target UE may include the eRedCap UE in the embodiments of the present disclosure.

That is, the third information may be cell access prohibition information carried in the SIB1 for the normal RedCap UE introduced in the R17.

Further, the multiple pieces of third information may be related to the number of RXs supported by the UE. The different pieces of third information may indicate whether UE with different numbers of RXs, of the target UE is prohibited from accessing the first cell. Exemplarily, the third information may include “cellBarredRedCap1Rx” and “cellBarredRedCap2Rx”.

In an embodiment of the present disclosure, the multiple pieces of third information may be used to indicate, together with the cell access prohibition information and any one of the first information, the multiple pieces of first sub-information, the second sub-information, or the third sub-information, whether the eRedCap UE is prohibited from accessing the first cell

In a possible implementation, when the first information is used as separate indication information, the multiple pieces of third information may indicate, together with the cell access prohibition information and the first information, whether the eRedCap UE is prohibited from accessing the first cell.

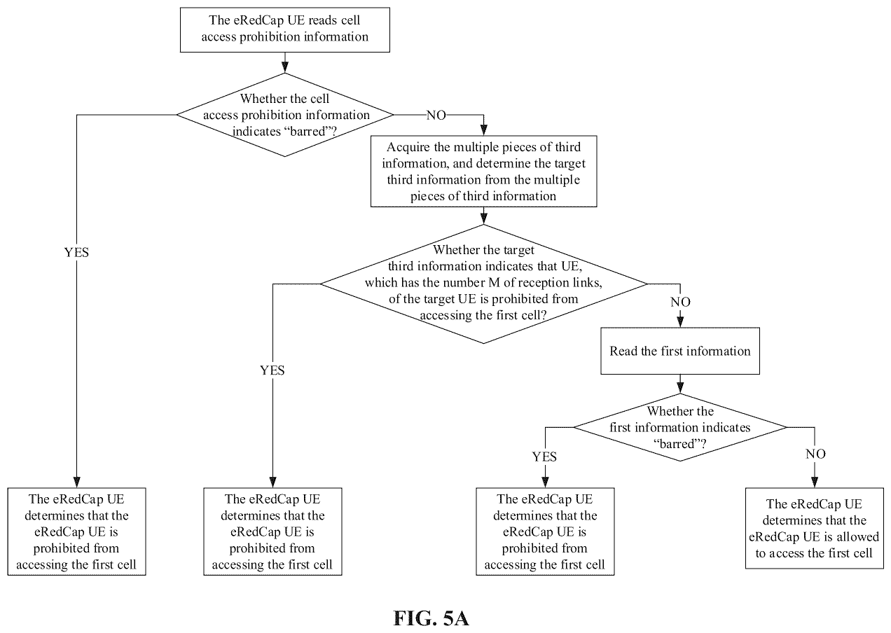

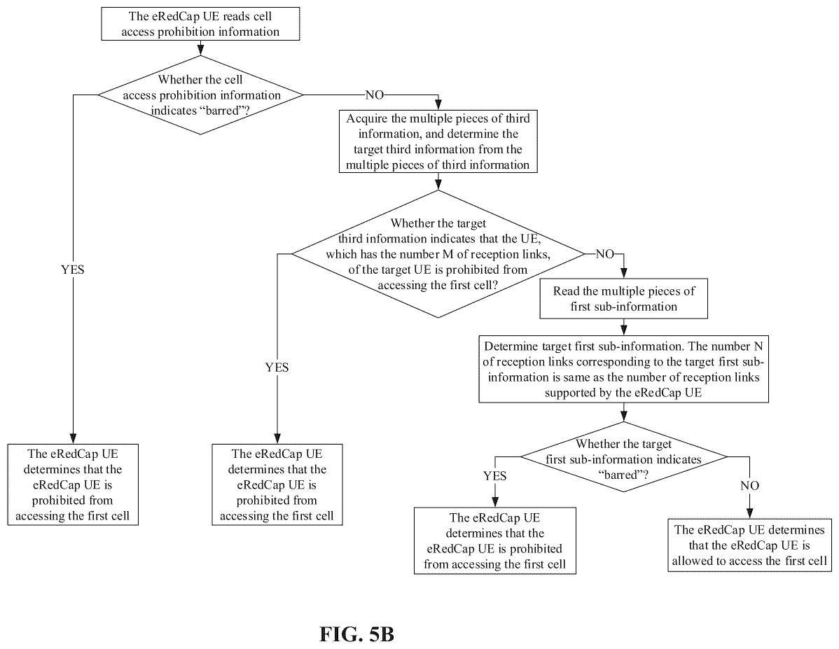

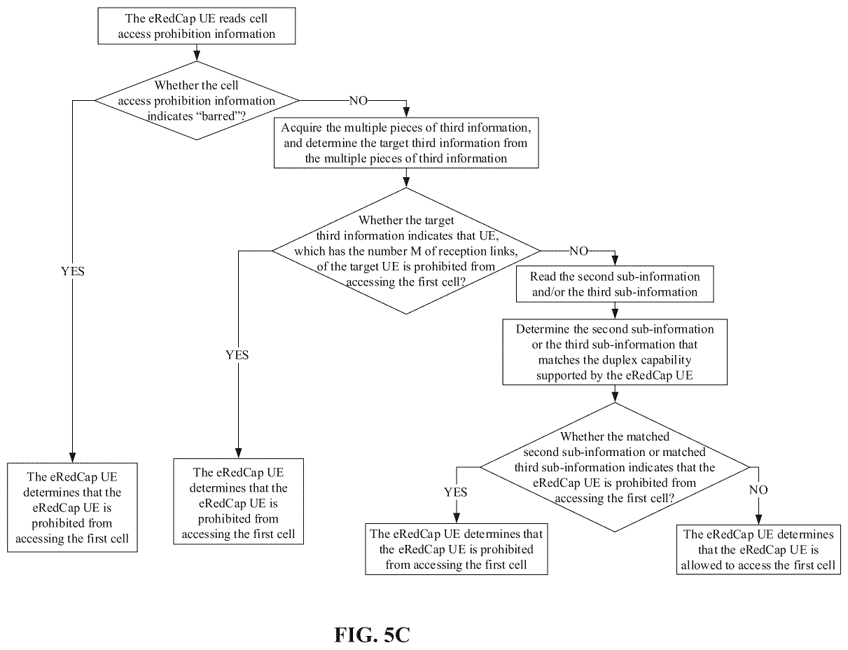

In this implementation, referring to the flowchart illustrated in FIG. 5A, the eRedCap UE may determine whether the eRedCap UE is prohibited from accessing the first cell according to the following manner.

In the first operation, the eRedCap UE reads cell access prohibition information.

In the second operation, the eRedCap UE determines whether the cell access prohibition information indicates “barred”.

In the third operation, if the cell access prohibition information indicates that the eRedCap UE is prohibited from accessing the first cell (i.e., indicates “barred”), the eRedCap UE determines that the eRedCap UE is prohibited from accessing the current first cell.

In the fourth operation, if the cell access prohibition information indicates that the eRedCap UE is not prohibited from accessing the first cell (that is, indicates “not barred”), the eRedCap UE acquires multiple pieces of third information, and determines target third information from the multiple pieces of third information. The number M of reception links corresponding to the target third information is the same as the number of reception links supported by the eRedCap UE.

That is, the eRedCap UE may firstly acquire the third information matching the number of links supported by the eRedCap UE from the multiple pieces of third information to obtain the target third information. Next, the eRedCap UE may determine whether the eRedCap UE is allowed to access the first cell according to the specific indication content of the target third information.

In the fifth operation, the eRedCap UE judges whether the target third information indicates that UE, which has the number M of reception links, of the target UE is prohibited from accessing the first cell.

In the sixth operation, if the target third information indicates that UE, which has the number M of reception links, of the target UE is prohibited from accessing the first cell, the eRedCap UE determines that the eRedCap UE is prohibited from accessing the first cell.

In the seventh operation, when the target third information indicates that UE, which has the number M of reception links, of the target UE is not prohibited from accessing the first cell, the eRedCap UE reads the first information.

In the eighth operation, the RedCap UE determines whether the eRedCap UE is prohibited from accessing the first cell according to the first information.

Alternatively, the operation that the eRedCap UE determines whether the eRedCap UE is prohibited from accessing the first cell according to the first information may be implemented by the following manner.

If the first information indicates “barred”, the eRedCap UE may consider that the eRedCap UE is prohibited from accessing the current first cell. If the first information indicates “not barred”, the eRedCap UE may consider that the eRedCap UE is allowed to access the current first cell.

Alternatively, the multiple pieces of third information in the fourth operation may replace access prohibition indication information for the normal RedCap UE, for example, “cellBarredRedCap”. Accordingly, the eRedCap UE may directly judge whether “cellBarredRedCap” indicates “barred”, if “barred” is indicated, the eRedCap UE determines that the eRedCap UE is prohibited from accessing the current first cell, and if “not barred” is indicated, the eRedCap UE continues to perform the eighth operation.

In another possible implementation, when the first information includes multiple pieces of first sub-information, the multiple pieces of third information may indicate, together with the cell access prohibition information and the plurality of first sub-information, whether the eRedCap UE is prohibited from accessing the first cell.

In this implementation, referring to the flowchart illustrated in FIG. 5B, the eRedCap UE may determine whether the eRedCap UE is prohibited from accessing the first cell according to the following manner.

In the first operation, the eRedCap UE reads cell access prohibition information.

In the second operation, the eRedCap UE determines whether the cell access prohibition information indicates “barred”.

In the third operation, if the cell access prohibition information indicates that the eRedCap UE is prohibited from accessing the first cell (i.e., indicates “barred”), the eRedCap UE determines that the eRedCap UE is prohibited from accessing the first cell.

In the fourth operation, if the cell access prohibition information indicates that the eRedCap UE is not prohibited from accessing the first cell (i.e., indicates “not barred”), the eRedCap UE determines target third information from multiple pieces of third information. The number M of reception links corresponding to the target third information is the same as the number of reception links supported by the eRedCap UE.

That is, the eRedCap UE may firstly acquire third information matching the number of links supported by the eRedCap UE from the multiple pieces of third information to obtain target third information. Next, the eRedCap UE may determine whether the eRedCap UE is allowed to access the first cell according to the specific indication content of the target third information.

In the fifth operation, the eRedCap UE determines whether the target third information indicates that the UE, which has the number M of reception links, of the target UE is prohibited from accessing the first cell.

In the sixth operation, if the target third information indicates that the UE, which has the number M of reception links, of the target UE is prohibited from accessing the first cell, the eRedCap UE determines that the eRedCap UE is prohibited from accessing the first cell.

In the seventh operation, if the target third information indicates that the UE, which has the number M of reception links, of the target UE is not prohibited from accessing the first cell, the eRedCap UE reads multiple pieces of first sub-information.

In the eighth operation, the eRedCap UE may determine whether the eRedCap UE is prohibited from accessing the first cell according to the number of supported reception links and the multiple pieces of first sub-information.

Alternatively, the operation that the eRedCap UE determines whether the eRedCap UE is prohibited from accessing the first cell according to the number of supported reception links and the multiple pieces of first sub-information may be implemented by the following manner.

Target first sub-information is determined. The number N of reception links corresponding to the target first sub-information is the same as the number of reception links supported by the eRedCap UE.

If the target first sub-information indicates that the eRedCap UE is prohibited from accessing the first cell, it is determined that the eRedCap UE is prohibited from accessing the first cell.

If the target first sub-information indicates that the eRedCap UE is not prohibited from accessing the first cell, it is determined that the eRedCap UE is allowed to access the first cell.

Alternatively, the multiple pieces of third information in the fourth step may replace access prohibition indication information for the normal RedCap UE, for example, “cellBarredRedCap”. Accordingly, the eRedCap UE may directly judge whether “cellBarredRedCap” indicates “barred”, if “barred” is indicated, the eRedCap UE determines that the eRedCap UE is prohibited from accessing the current first cell, and if “not barred” is indicated, the eRedCap UE continues to perform the eighth operation.

In yet another possible implementation, when the first information includes the second sub-information and/or the third sub-information, the multiple pieces of third information may indicate, together with the cell access prohibition information and the second sub-information and/or the third sub-information, whether the eRedCap UE is prohibited from accessing the first cell.

In this implementation, referring to the flowchart illustrated in FIG. 5C, the eRedCap UE may determine whether the eRedCap UE is prohibited from accessing the first cell according to the following manner.

In the first operation, the eRedCap UE reads cell access prohibition information.

In the second operation, the eRedCap UE judges whether the cell access prohibition information indicates “barred”.

In the third operation, if the cell access prohibition information indicates that the eRedCap UE is prohibited from accessing the first cell (i.e., indicates “barred”), the eRedCap UE determines that the eRedCap UE is prohibited from accessing the first cell.

In the fourth operation, if the cell access prohibition information indicates that the eRedCap UE is not prohibited from accessing the first cell (i.e., indicates “not barred”), the eRedCap UE determines target third information from multiple pieces of third information. The number M of reception links corresponding to the target third information is the same as the number of reception links supported by the eRedCap UE.

That is, the eRedCap UE may firstly acquire the third information matching the number of links supported by the eRedCap UE from the multiple pieces of third information to obtain the target third information. Next, the eRedCap UE may determine whether the eRedCap UE is allowed to access the first cell according to the specific indication content of the target third information.

In the fifth operation, the eRedCap UE determines whether the target third information indicates that the UE, which has the number M of reception links, of the target UE is prohibited from accessing the first cell.

In the sixth operation, if the target third information indicates that the UE, which has the number M of reception links, of the target UE is prohibited from accessing the first cell, the eRedCap UE determines that the eRedCap UE is prohibited from accessing the first cell.

In the seventh operation, if the target third information indicates that the UE, which has the number M of reception links, of the target UE is not prohibited from accessing the first cell, the eRedCap UE reads the second sub-information and/or the third sub-information.

In the eighth operation, the eRedCap UE may determine whether the eRedCap UE is prohibited from accessing the first cell according to the second sub-information and/or the third sub-information and the duplex capability supported by the eRedCap UE.

Alternatively, the operation of determining whether the eRedCap UE is prohibited from accessing the first cell according to the second sub-information and/or the third sub-information and the duplex capability supported by the eRedCap UE may be implemented by the following manner.

The second sub-information or third sub-information matching duplex capability supported by the eRedCap UE is determined.

If the matched second sub-information or third sub-information indicates that the eRedCap UE is prohibited from accessing the first cell, it is determined that the eRedCap UE is prohibited from accessing the first cell.

If the matched second sub-information or third sub-information indicates that the eRedCap UE is not prohibited from accessing the first cell, it is determined that the eRedCap UE is allowed to access the first cell.

Alternatively, the multiple pieces of third information in the fourth operation may replace access prohibition indication information for the normal RedCap UE, for example, “cellBarredRedCap”. Accordingly, the eRedCap UE may directly determine whether “cellBarredRedCap” indicates “barred”, if “barred” is indicated, the eRedCap UE determines that the eRedCap UE is prohibited from accessing the current first cell, and if “not barred” is indicated, the eRedCap UE continues to perform the eighth operation.

In summary, in the communication processing method provided by the embodiment of the present disclosure, the cell access state of the eRedCap UE may be indicated by the first information and the multiple pieces of sub-information configured by the eRedCap UE, the cell access prohibition information (“cellbarred”) in the MIB and the cell access prohibition information (that is, the multiple pieces of third information) for the normal RedCap UE. The newly introduced cell access control information may be compatible with the existing cell access parameters, and the flexibility of network device configuration can be improved at the same time.

Hereinafter, the intra frequency cell reselection for the eRedCap UE is described in detail.

In an embodiment of the present disclosure, in a case that a target parameter, that is, a parameter indicating whether the eRedCap UE is allowed to perform intra frequency cell reselection, is not configured in the cell access control information, the terminal device may determine that the eRedCap UE is prohibited from accessing the first cell.

It may be understood that in a case that a parameter indicating whether the eRedCap UE is allowed to perform intra frequency cell reselection does not appear in the SIB, the eRedCap UE may consider that the eRedCap UE is prohibited from accessing the current first cell, that is, the current first cell does not support the eRedCap UE.

It may be seen that the network device may indicate that the eRedCap UE is prohibited from accessing the first cell by the first information when the target parameter is not configured, thereby reducing the signaling overhead of the configuration information and improving the configuration flexibility of the cell access control.

In an embodiment of the present disclosure, the first information may include multiple pieces of fourth sub-information, and the fourth sub-information is related to the number of RXs supported by the UE.

In the embodiment of the present disclosure, each piece of fourth sub-information is used to indicate whether UE, which has a number L of reception links, of the eRedCap UE is allowed to perform the intra frequency cell reselection. L is greater than or equal to 1, and different pieces of fourth sub-information correspond to different numbers L of reception links.

That is, different pieces of fourth sub-information may be used to respectively indicate whether UE, which has different numbers of reception links, of the eRedCap UE is allowed to perform intra frequency cell reselection.

Alternatively, “intraFreqReselectionRedCap1RXEnhanced” may indicate whether eRedCap UE supporting one RX is allowed to perform intra frequency cell reselection, and “intraFreqReselectionRedCap2RXEnhanced” may indicate whether eRedCap UE supporting two RXs is allowed to perform intra frequency cell reselection. It should be noted that the first information may also be distinguished according to eRedCap UE has a greater number of reception links, and this is not enumerated one by one in the embodiment of the present disclosure.

Exemplarily, if “intraFreqReselectionRedCap1RXEnhanced” indicates “true”, all eRedCap UE supporting one RX in the network may consider that the eRedCap UE may perform intra frequency cell reselection after the eRedCap UE is prohibited from accessing the first cell. If “intraFreqReselectionRedCap1RXEnhanced” indicates “false”, all eRedCap UE supporting one RX in the network may consider that the eRedCap UE is not allowed to perform intra frequency cell reselection after the eRedCap UE is prohibited from accessing the first cell.

It may be seen that, in the communication processing method provided by the embodiment of the present disclosure, the intra frequency cell reselection information may be separately configured for eRedCap UE having different RX numbers, so as to facilitate the intra frequency cell access control for a part of UE of the eRedCap UE, thereby further reducing the granularity of the cell access control and improving the flexibility of the cell access control.

A specific method for determining whether the eRedCap UE is allowed to perform intra frequency cell reselection is described in detail below.

In an embodiment of the present disclosure, the eRedCap UE may determine whether the eRedCap UE is allowed to perform intra frequency cell reselection according to the following manner.

The eRedCap UE determines, based on the first information, whether the eRedCap UE is allowed to perform intra frequency cell reselection.

Alternatively, the eRedCap UE determines, according to the number of reception links supported by the eRedCap UE and the multiple pieces of fourth sub-information, whether to perform intra frequency cell reselection.

In a possible implementation, when the first information is used to indicate whether the RedCap UE is allowed to perform intra frequency cell reselection, the eRedCap UE may directly determine whether the eRedCap UE is allowed to perform intra frequency cell reselection according to the indication content of the first information.

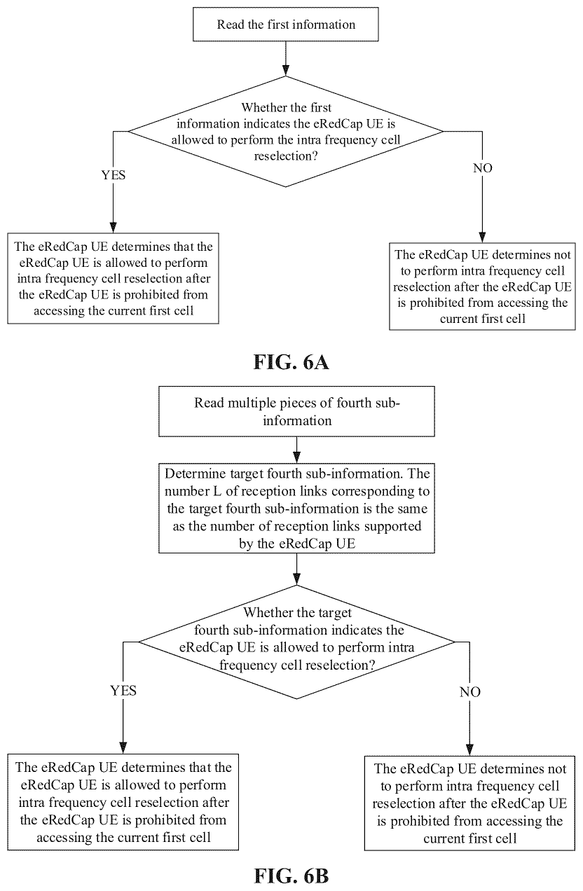

In this implementation, referring to the flowchart illustrated in FIG. 6A, the eRedCap UE may determine whether the eRedCap UE is prohibited from accessing the first cell according to the following manner.

The first operation is reading the first information.

The second operation is determining whether the eRedCap UE is allowed to perform the intra frequency cell reselection according to the first information.

The operation that the eRedCap UE determines whether the eRedCap UE is allowed to perform the intra frequency cell reselection according to the first information may be implemented by the following manner.

Whether the first information indicates that the eRedCap UE is allowed to perform intra frequency cell reselection is judged.

If the first information indicates that the eRedCap UE is allowed to perform intra frequency cell reselection, the eRedCap UE determines that the eRedCap UE is allowed to perform intra frequency cell reselection after the eRedCap UE is prohibited from accessing the current first cell.

If the first information indicates that the eRedCap UE is not allowed to perform intra frequency cell reselection, the eRedCap UE determines not to perform intra frequency cell reselection after the eRedCap UE is prohibited from accessing the current first cell.

In another possible implementation, when the first information includes multiple pieces of fourth sub-information, the eRedCap UE may determine, according to the number of reception links supported by the eRedCap UE and the multiple pieces of fourth sub-information, whether to allow the intra frequency cell reselection.

In this implementation, referring to the flowchart illustrated in FIG. 6B, the eRedCap UE may determine whether the eRedCap UE is allowed to perform intra frequency cell reselection according to the following manner.

The first operation is reading multiple pieces of fourth sub-information in the SIB.

The second operation is determining, according to the number of reception links supported by the eRedCap UE and the multiple pieces of fourth sub-information, whether the eRedCap UE is allowed to perform the intra frequency cell reselection.

The operation that the eRedCap UE determines, according to the number of reception links supported by the eRedCap UE and the multiple pieces of fourth sub-information, whether the eRedCap UE is allowed to perform the intra frequency cell reselection may be implemented by the following manner.

Target fourth sub-information is determined. The number L of reception links corresponding to the target fourth sub-information is the same as the number of reception links supported by the UE.

If the target fourth sub-information indicates that UE, which has a number L of reception links, of the eRedCap UE is allowed to perform the intra frequency cell reselection, the eRedCap UE is allowed to perform the intra frequency cell reselection after prohibiting access to the first cell.

If the target fourth sub-information indicates that UE, which has a number L of reception links, of the eRedCap UE is prohibited from performing the intra frequency cell reselection, the eRedCap UE does not perform the intra frequency cell reselection after prohibiting access to the first cell.

It may be understood that the eRedCap UE may firstly acquire the fourth sub-information matching the number of RXs supported by the eRedCap UE from the multiple pieces of fourth sub-information to obtain the target fourth sub-information. Next, the eRedCap UE may determine whether the eRedCap UE is allowed to perform the intra frequency cell reselection according to the specific indication content of the target fourth sub-information.

Exemplarily, in a scenario in which the network device indicates whether eRedCap UE supporting one RX is allowed to perform the intra frequency cell reselection by “intraFreqReselectionRedCap1RXEnhanced” and indicates whether eRedCap UE supporting two RXs is allowed to perform the intra frequency cell reselection by “intraFreqReselectionRedCap2RXEnhanced”, after receiving the SIB1, the eRedCap UE may read “intraFreqReselectionRedCap2RXEnhanced” or “intraFreqReselectionRedCap2RXEnhanced” carried in the SIB1 according to the number of RXs supported by the eRedCap UE.

If the eRedCap UE supports one RX, the eRedCap UE may read “intraFreqReselectionRedCap1RXEnhanced” in SIB1. If the information indicates “true”, the eRedCap UE may consider that the eRedCap UE may perform the intra frequency cell reselection after prohibiting from accessing the first cell, and if the indication information indicates “false”, the eRedCap UE may consider that the eRedCap UE does not perform the intra frequency cell reselection after prohibiting from accessing the first cell. Accordingly, if the eRedCap UE supports RXs, two the eRedCap UE may read “intraFreqReselectionRedCap2RXEnhanced” in SIB1. If the information indicates “true”, the eRedCap UE may consider that the eRedCap UE may perform the intra frequency cell reselection after prohibiting from accessing the first cell, and if the indication information indicates “false”, the eRedCap UE may consider that the eRedCap UE does not perform the intra frequency cell reselection after prohibiting from accessing the first cell.

Alternatively, the first information may further include the fifth information and/or the sixth information. Exemplarily, the fifth sub-information may indicate whether the eRedCap UE supporting half duplex is allowed to perform the intra frequency cell reselection, and the sixth sub-information may be used to indicate whether the eRedCap UE supporting full duplex is allowed to perform the intra frequency cell reselection.

Based on this, the eRedCap UE may determine whether to perform the intra frequency cell reselection according to the duplex capability supported by the eRedCap UE and the fifth sub-information and/or the sixth sub-information.

Specifically, the eRedCap UE may determine the fifth sub-information or the sixth sub-information that matches the duplex capability supported by the eRedCap UE.

If the matched fifth sub-information or matched sixth sub-information indicates that the eRedCap UE is prohibited from performing the intra frequency cell reselection, it is determined that the eRedCap UE is prohibited from performing the intra frequency cell reselection after the eRedCap UE is prohibited from accessing the first cell.

If the matched fifth sub-information or matched sixth sub-information indicates that the eRedCap UE is allowed to perform the intra frequency cell reselection, it is determined that the eRedCap UE is allowed to perform the intra frequency cell reselection after the eRedCap UE is prohibited from accessing the first cell.

Exemplarily, in a scenario in which the eRedCap UE supports half-duplex capability, the eRedCap UE may select the fifth sub-information to perform a judgment for intra frequency cell reselection. If the fifth sub-information indicates “true”, it may be considered that the eRedCap UE supporting half-duplex may perform the intra frequency cell reselection after prohibiting access to the first cell. If the fifth sub-information indicates “false”, it may be considered that the eRedCap UE supporting half-duplex is not allowed to perform the intra frequency cell reselection after prohibiting access to the current first cell. In a scenario in which the eRedCap UE supports full-duplex capability, the eRedCap UE may select the sixth sub-information to perform a judgment for intra frequency cell reselection. If the sixth sub-information indicates “true”, all eRedCap UE supporting full-duplex may consider that the eRedCap UE may perform the intra frequency cell reselection after prohibiting access to the first cell. If the sixth sub-information indicates “false”, the eRedCap UE supporting full duplex may consider that the eRedCap UE is not allowed to perform the intra frequency cell reselection after prohibiting access to the first cell.

In summary, in the embodiment of the present disclosure, the IFRI parameter is separately configured for the eRedCap UE, and the network can implement more flexible intra frequency cell reselection control for the eRedCap UE according to different deployments.

In an embodiment of the present disclosure, the network device may configure the second information for one or more neighboring cell frequency points to indicate whether the frequency point corresponding to the second information supports the eRedCap UE.

Alternatively, in the embodiment of the present disclosure, after receiving the at least one piece of second information, the eRedCap UE may take a frequency point to which the eRedCap UE is allowed to be accessed as a candidate frequency point for cell reselection based on the at least one piece of second information.

Exemplarily, the network device may configure one piece of second information on each frequency point for the eRedCap UE. For example, “redCapAccessAllowedEnhanced” is used to indicate whether the eRedCap UE is allowed to access the frequency point. When the second information is configured in a certain band in the inter frequency point list, and the second information indicates “true”, it means that the eRedCap UE is allowed to access the frequency point. For the eRedCap UE, if the network is configured with the inter frequency point list, the eRedCap UE sets relevant cell reselection parameters only by taking frequency points configured with redCapAccessAllowedEnhanced indication information as inter frequency points for cell reselection.

Alternatively, in the embodiment of the present disclosure, similar to the above-described embodiment, the network device may further divide the second information into multiple pieces of sub-information according to the number of RXs supported by the UE and the duplex capability, so as to realize more refined control for the inter frequency cell reselection. Exemplarily, the second information may include multiple pieces of fifth sub-information, and each piece of fifth information may be used to indicate whether the eRedCap UE having K RXs is allowed to access the current frequency point, that is, whether the current frequency point supports the eRedCap UE having K RXs. The different pieces of fifth sub-information correspond to the different number of RXs. Alternatively, the second information may include the sixth sub-information and/or the seventh sub-information. The sixth sub-information may indicate whether the current frequency point supports the half-duplex eRedCap UE. The seventh sub-information may indicate whether the current frequency point supports the full-duplex eRedCap UE.

In the embodiment of the present disclosure, the access indication of the inter frequency point is configured separately for the eRedCap UE, and the network can implement more flexible inter frequency cell reselection control for the eRedCap UE according to different deployments.

The preferred embodiments of the present disclosure have been described in detail above with reference to the accompanying drawings, but the present disclosure is not limited to the specific details in the above-described embodiments. Within the scope of the technical concept of the present disclosure, various simple modifications may be made to the technical solutions of the present disclosure, and these simple modifications all fall within the scope of protection of the present disclosure. For example, various specific technical features described in the above-described detailed embodiments may be combined in any suitable manner without contradiction, and various possible combinations will not be described separately in this disclosure in order to avoid unnecessary repetition. For example, various embodiments of the present disclosure may be combined arbitrarily, and as long as they do not violate the idea of the present disclosure, they should also be regarded as the disclosure of the present disclosure. For another example, on the premise that there is no conflict, each embodiment described in the present disclosure and/or the technical features in each embodiment can be arbitrarily combined with the prior art, and the technical solution obtained after the combination should also fall within the scope of protection of the present disclosure.

It should also be understood that in various method embodiments of the present disclosure, the size of the sequence number of the above-described processes does not mean the sequence of execution, and the sequence of execution of each process should be determined by its function and internal logic, and should not constitute any limitation on the implementation of the embodiments of the present disclosure. In addition, in the embodiment of the present disclosure, the terms “downlink”, “uplink” and “sidelink” are used to indicate the transmission direction of signals or data. The “downlink” is used to indicate that the transmission direction of signals or data is the first direction transmitted from the station to the UE of the cell, and the “uplink” is used to indicate that the transmission direction of signals or data is the second direction transmitted from the UE of the cell to the station. The “sidelink” is used to indicate that the transmission direction of the signal or data is the third direction transmitted from the UE 1 to the UE 2. For example, “downlink signal” indicates that the transmission direction of the signal is the first direction. In addition, in the embodiment of the present disclosure, the term “and/or” is only used for describing one kind of association relationship describing association objects, and indicates that there may be three kinds of relationships. Specifically, A and/or B may represent three cases of: A exists alone, A and B exist simultaneously, and B exists alone. In addition, the character “/” in the present disclosure generally indicates that there is an “or” relationship between the association objects.

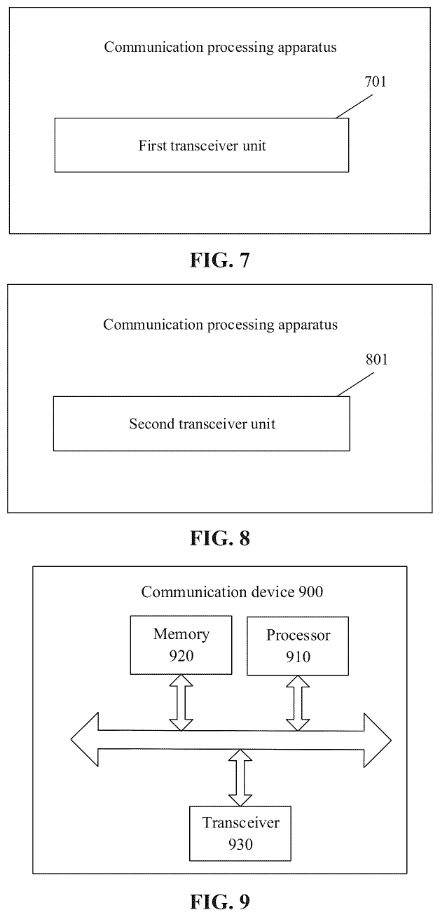

FIG. 7 is the first schematic diagram of the structure of a communication processing apparatus according to an embodiment of the present disclosure. The apparatus is applied to a terminal device. As illustrated in FIG. 7, the communication processing apparatus includes the first transceiver unit 701.

The first transceiver unit 701 is configured to receive the first information related to cell access of RedCap UE. The RedCap UE refers to a terminal device that supports a maximum bandwidth of less than 20 MHz.

Alternatively, the first information is used to indicate at least one of: whether the RedCap UE is prohibited from accessing a first cell; whether the RedCap UE is allowed to perform intra frequency cell reselection; or at least one piece of second information. The at least one piece of second information corresponds to at least one frequency point, and each piece of second information is used to indicate whether the RedCap UE is allowed to access a frequency point corresponding to the second information

Alternatively, the first information includes multiple pieces of first sub-information, each piece of first sub-information is used to indicate whether UE, which supports a number N of reception links, of the RedCap UE is prohibited from accessing the first cell, N is greater than or equal to 1, and different pieces of first sub-information correspond to different numbers N of reception links.

Alternatively, the first information includes the second sub-information and/or the third sub-information. The second sub-information is used to indicate whether UE, which supports half duplex, of the RedCap UE is prohibited from accessing the first cell, and the third sub-information is used to indicate whether UE, which supports full duplex, of the RedCap UE is prohibited from accessing the first cell.

Alternatively, the terminal device is the RedCap UE, and the communication processing apparatus 700 may further include a processing unit. The processing unit may be configured to perform any one of: determining, according to the first information, whether the terminal device is prohibited from accessing the first cell; determining, according to a number of reception links supported by the terminal device and multiple pieces of first sub-information, whether the terminal device is prohibited from accessing the first cell; or determining, according to the second sub-information and/or the third sub-information and a duplex capability supported by the terminal device, whether the terminal device is prohibited from accessing the first cell

Alternatively, the processing unit is further configured to determine that the RedCap UE is prohibited from accessing the first cell in a case that a target parameter is not configured in the first information. The target parameter is a parameter indicating whether the RedCap UE is allowed to perform the intra frequency cell reselection.

Alternatively, the first transceiver unit 701 is further configured to receive cell access prohibition information.

The cell access prohibition information is used to indicate, together with the first information, whether the RedCap UE is prohibited from accessing the first cell.

Alternatively, the cell access prohibition information is used to indicate, together with multiple pieces of first sub-information, whether the RedCap UE is prohibited from accessing the first cell.

Alternatively, the cell access prohibition information is used to indicate, together with the second sub-information and/or the third sub-information, whether the RedCap UE is prohibited from accessing the first cell.

Alternatively, the terminal device is the RedCap UE, and the processing unit is further configured to determine that the terminal device is prohibited from accessing the first cell in a case that the cell access prohibition information indicates that the terminal device is prohibited from accessing the first cell, and in a case that the cell access prohibition information indicates that the terminal device is not prohibited from accessing the first cell, the processing unit is further configured to perform any one of: determining, according to the first information, whether the terminal device is prohibited from accessing the first cell; determining, according to a number of reception links supported by the terminal device and the multiple pieces of first sub-information, whether the terminal device is prohibited from accessing the first cell; or determining, according to the second sub-information and/or the third sub-information and a duplex capability supported by the terminal device, whether the terminal device is prohibited from accessing the first cell

Alternatively, the first transceiver unit 701 is further configured to receive multiple pieces of third information. Each piece of third information is used to indicate whether UE, that supports a number M of reception links, of target UE is prohibited from accessing the first cell. M is greater than or equal to 1, and different pieces of third information correspond to different numbers M of reception links. The target UE refers to UE that supports a maximum bandwidth of less than or equal to 20 MHz.

The multiple pieces of third information are used to indicate, together with the cell access prohibition information and any one of the first information, the multiple pieces of first sub-information, the second sub-information, or the third sub-information, whether the RedCap UE is prohibited from accessing the first cell.

Alternatively, the terminal device is the RedCap UE, and the processing unit is further configured to determine not to access the first cell in a case that the cell access prohibition information indicates that the terminal device is prohibited from accessing the first cell; determine target third information in a case that the cell access prohibition information indicates that the terminal device is not prohibited from accessing the first cell; determine that the terminal device is prohibited from accessing the first cell in a case that the target third information indicates that the UE, which has a number M of reception links, of the target UE is prohibited from accessing the first cell; and in a case that the target third information indicates that the UE, which has the number M of reception links, of the target UE is not prohibited from accessing the first cell, perform any one of: determining according to the first information, whether the terminal device is prohibited from accessing the first cell; determining according to the number of reception links supported by the terminal device and the multiple pieces of first sub-information, whether the terminal device is prohibited from accessing the first cell; or determining according to the second sub-information and/or the third sub-information and a duplex capability supported by the terminal device, whether the terminal device is prohibited from accessing the first cell. A number M of reception links corresponding to the target third information is same as a number M of reception links supported by the terminal device.

Alternatively, the processing unit is further configured to determine that the terminal device is prohibited from accessing the first cell if the first information indicates that the RedCap UE is prohibited from accessing the first cell; and determine that the terminal device is allowed to access the first cell if the first information indicates that the RedCap UE is not prohibited from accessing the first cell.

Alternatively, the processing unit is further configured to determine target first sub-information; and if the target first sub-information indicates that the RedCap UE is prohibited from accessing the first cell, determine that the terminal device is prohibited from accessing the first cell; if the target first sub-information indicates that the RedCap UE is not prohibited from accessing the first cell, determine that the terminal device is allowed to access the first cell. A number N of reception links corresponding to the target first sub-information is same as the number of reception links supported by the terminal device.

Alternatively, the processing unit is further configured to determine the second sub-information or the third sub-information that matches the duplex capability supported by the terminal device; if the matched second sub-information or the matched third sub-information indicates that the RedCap UE is prohibited from accessing the first cell, determine that the terminal device is prohibited from accessing the first cell; and if the matched second sub-information or matched third sub-information indicates that the RedCap UE is not prohibited from accessing the first cell, determine that the terminal device is allowed to access the first cell.

Alternatively, the first information further includes multiple pieces of fourth sub-information, each piece of fourth sub-information is used to indicate whether UE, which has a number L of reception links, of the RedCap UE is allowed to perform the intra frequency cell reselection, L is greater than or equal to 1, and different pieces of fourth sub-information correspond to different numbers L of reception links.

Alternatively, the terminal device is the RedCap UE, and the processing unit is further configured to determine, based on the first information, whether the terminal device is allowed to perform the intra frequency cell reselection; or determine, according to a number of reception links supported by the terminal device and the multiple pieces of fourth sub-information, whether to perform the intra frequency cell reselection.

Alternatively, the processing unit is further configured to determine that the terminal device is allowed to perform the intra frequency cell reselection after prohibiting access to the first cell if the first information indicates that the RedCap UE is allowed to perform the intra frequency cell reselection; and determine that the terminal device does not perform the intra frequency cell reselection after prohibiting access to the first cell if the first information indicates that the RedCap UE is not allowed to perform the intra frequency cell reselection.

Alternatively, the processing unit is further configured to determine target fourth sub-information. A number L of reception links corresponding to the target fourth sub-information is same as the number of reception links supported by the terminal device. If the target fourth sub-information indicates that UE, which has a number L of reception links, of the RedCap UE is allowed to perform the intra frequency cell reselection, the terminal device is allows to perform the intra frequency cell reselection after prohibiting access to the first cell; and if the target fourth sub-information indicates that the UE, which has a number L of reception links, of the RedCap UE is prohibited from performing the intra frequency cell reselection, the terminal device does not perform the intra frequency cell reselection after prohibiting access to the first cell.

Alternatively, the terminal device is the RedCap UE, and the processing unit is further configured to take, based on the at least one piece of second information, a frequency point to which the RedCap UE is allowed to be accessed as a candidate frequency point for cell reselection.

Alternatively, a baseband bandwidth supported by the RedCap UE is less than or equal to 5 MHz, or a maximum baseband bandwidth supported by a physical shared channel of the RedCap UE is less than or equal to 5 MHz.

FIG. 8 is the second schematic diagram of the structure of the communication processing apparatus according to an embodiment of the present disclosure. The apparatus is applied to a network device.

The second transceiver unit 801 is configured to transmit the first information related to cell access of RedCap UE. The RedCap UE refers to a terminal device that supports a maximum bandwidth of less than 20 MHz.

Alternatively, the first information is used to indicate at least one of: whether the RedCap UE is prohibited from accessing a first cell; whether the RedCap UE is allowed to perform intra frequency cell reselection; or at least one piece of second information. The at least one piece of second information corresponds to at least one frequency point, and each piece of second information is used to indicate whether the RedCap UE is allowed to access a frequency point corresponding to the second information.

Alternatively, the first information includes multiple pieces of first sub-information, each piece of first sub-information is used to indicate whether UE, which supports a number N of reception links, of the RedCap UE is prohibited from accessing the first cell, N is greater than or equal to 1, and different pieces of first sub-information correspond to different numbers N of reception links.

Alternatively, the first information includes the second sub-information and/or the third sub-information. The second sub-information is used to indicate whether UE, which supports half duplex, of the RedCap UE is prohibited from accessing the first cell, and the third sub-information is used to indicate whether UE, which supports full duplex, of the RedCap UE is prohibited from accessing the first cell.

Alternatively, in a case that a target parameter is not configured in the first information, the first information is further used to indicate that the RedCap UE is prohibited from accessing the first cell. The target parameter is a parameter indicating whether the RedCap UE is allowed to perform the intra frequency cell reselection.

Alternatively, the second transceiver unit 801 is further configured to transmit cell access prohibition information.

The cell access prohibition information is used to indicate, together with the first information, whether the RedCap UE is prohibited from accessing the first cell.

Alternatively, the cell access prohibition information is used to indicate, together with multiple pieces of first sub-information, whether the RedCap UE is prohibited from accessing the first cell.

Alternatively, the cell access prohibition information is used to indicate, together with second sub-information and/or third sub-information, whether the RedCap UE is prohibited from accessing the first cell.

Alternatively, the second transceiver unit 801 is further configured to transmit multiple pieces of third information. Each piece of third information is used to indicate whether UE, which supports a number M of reception links, of target UE is prohibited from accessing the first cell, M is greater than or equal to 1, and different pieces of third information correspond to different numbers M of reception links.

The multiple pieces of third information are used to indicate, together with the cell access prohibition information and any one of the first information, the multiple pieces of first sub-information, the second sub-information, or the third sub-information, whether the RedCap UE is prohibited from accessing the first cell.

Alternatively, the first information further includes multiple pieces of fourth sub-information, each piece of fourth sub-information is used to indicate whether UE, which has a number L of reception links, of the RedCap UE is allowed to perform the intra frequency cell reselection, L is greater than or equal to 1, and different pieces of fourth sub-information correspond to different numbers L of reception links.

Alternatively, a baseband bandwidth supported by the RedCap UE is less than or equal to 5 MHz, or a maximum baseband bandwidth supported by a physical shared channel of the RedCap UE is less than or equal to 5 MHz.

Those skilled in the art should understand that the related description of the above communication processing apparatus according to the embodiment of the present disclosure may be understood with reference to the related description of the communication processing method according to the embodiment of the present disclosure.

In the communication processing method provided by the embodiments of the present disclosure, the terminal device may receive the first information transmitted by the network device. The first information is related to cell access of the RedCap UE, and the RedCap UE refers to UE that supports a maximum bandwidth of less than 20 MHz. That is, the network device may configure unique cell access information for the RedCap UE that supports a maximum bandwidth of less than 20 MHz, and separately manage the cell access of this type of RedCap UE, thereby realizing a more flexible and refined cell access mechanism.

FIG. 9 is a schematic structural diagram of a communication device 900 according to an embodiment of the present disclosure. The communication device may be a terminal device or a network device. The communication device 900 illustrated in FIG. 9 includes a processor 910. The processor 910 may invoke and execute a computer program from a memory to implement the method in the embodiments of the present disclosure.

Alternatively, as illustrated in FIG. 9, the communication device 900 may further include a memory 920. The processor 910 may invoke and execute the computer program from the memory 920 to implement the methods in the embodiments of the present disclosure.

The memory 920 may be a separate device independent of the processor 910 or may be integrated in the processor 910.

Alternatively, as illustrated in FIG. 9, the communication device 900 may further include a transceiver 930. The processor 910 may control the transceiver 930 to communicate with other devices, specifically, may transmit information or data to other devices, or may receive information or data transmitted by other devices.

The transceiver 930 may include a transmitter and a receiver. The transceiver 930 may further include one or more antennas.

Alternatively, the communication device 900 may specifically be the network device in the embodiments of the present disclosure, and the communication device 900 may implement the corresponding processes implemented by the network device in various methods of the embodiments of the present disclosure, which will not be described herein for the sake of brevity.

Alternatively, the communication device 900 may specifically be the mobile terminal/terminal device in the embodiments of the present disclosure, and the communication device 900 may implement corresponding processes implemented by the mobile terminal/terminal device in various methods of the embodiments of the present disclosure, which will not be described herein for the sake of brevity.

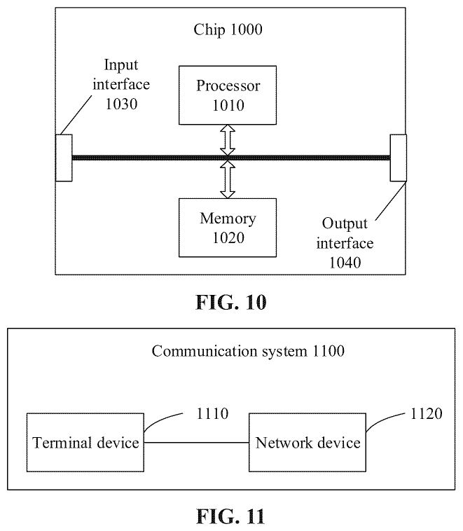

FIG. 10 is a schematic structural diagram of a chip according to an embodiment of the present disclosure. The chip 1000 illustrated in FIG. 10 includes a processor 1010, and the processor 1010 may invoke and execute a computer program from a memory to implement the methods in the embodiments of the present disclosure.

Alternatively, as illustrated in FIG. 10, the chip 1000 may further include a memory 1020. The processor 1010 may invoke and execute a computer program from the memory 1020 to implement the methods in the embodiments of the present disclosure.

The memory 1020 may be a separate device independent of the processor 1010 or may be integrated in the processor 1010.

Alternatively, the chip 1000 may further include an input interface 1030. The processor 1010 may control the input interface 1030 to communicate with other devices or chips, specifically, may acquire information or data transmitted by other devices or chips.

Alternatively, the chip 1000 may further include an output interface 1040. The processor 1010 may control the output interface 1040 to communicate with other devices or chips, specifically, may output information or data to other devices or chips.

Alternatively, the chip may be applied to the network device in the embodiments of the present disclosure, and the chip may implement the corresponding processes implemented by the network device in various methods of the embodiments of the present disclosure, which will not be described herein for the sake of brevity.

Alternatively, the chip may be applied to the mobile terminal/terminal device in the embodiments of the present disclosure, and the chip may implement the corresponding processes implemented by the mobile terminal/terminal device in various methods of the embodiments of the present disclosure.

It should be understood that the chip mentioned in the embodiment of the present disclosure may be called a system level chip, a system chip, a chip system or a system-on-chip or the like.

FIG. 11 is a schematic block diagram of a communication system 1100 according to an embodiment of the present disclosure. As illustrated in FIG. 11, the communication system 1100 includes the terminal device 1110 and the network device 1120.

The terminal device 1110 may be configured to implement the corresponding functions implemented by the terminal device in the above methods, and the network device 1120 may be configured to implement the corresponding functions implemented by the network device in the above methods, which will not be described herein for the sake of brevity.

It should be understood that the processor of the embodiments of the present disclosure may be an integrated circuit chip having signal processing capabilities. In the implementation process, the operations of the above method embodiments may be completed by integrated logic circuits of hardware in the processor or instructions in the form of software. The processor described above may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, operations, and logical block diagrams disclosed in the embodiments of the present disclosure may be implemented or executed. The general-purpose processor may be a microprocessor or the processor may be any conventional processor or the like. The operations of the method disclosed in combination with the embodiments of the present disclosure may be directly embodied as execution by the hardware decoding processor, or may be executed by a combination of hardware and software modules in the decoding processor. The software module may be located in a Random Access Memory (RAM), a flash memory, a Read-Only Memory (ROM), a Programmable ROM (PROM), an electrically erasable PROM (EEPROM), a register and other storage medium mature in the art. The storage medium is located in the memory, and the processor reads the information in the memory and completes the operations of the methods in combination with its hardware.

It is understood that the memory in the embodiments of the present disclosure may be a volatile memory or a non-volatile memory, or may include both volatile and non-volatile memory. The non-volatile memory may be a ROM, a PROM, an Erasable PROM (EPROM), an EEPROM, or a flash memory. The volatile memory may be a RAM, which serves as an external cache. By way of illustration, but not limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM) and Direct Rambus RAM (DR RAM). It should be noted that the memory of the systems and methods described herein is intended to include, but is not limited to, these and any other suitable type of memory.

It should be understood that the above memory is exemplary, but not limiting, and, for example, the memory in embodiments of the present disclosure may also be an SRAM, a DRAM, an SDRAM, a DDR SDRAM, an ESDRAM, an SLDRAM, a DR RAM, etc. That is, the memory in embodiments of the present disclosure is intended to include but not limited to these and any other suitable types of memory.

Embodiments of the present disclosure further provide a computer readable storage medium for storing a computer program.

Alternatively, the computer readable storage medium may be applied to the network device in the embodiments of the present disclosure, and the computer program causes the computer to perform the corresponding processes implemented by the network device in various methods of the embodiments of the present disclosure, which will not be described herein for the sake of brevity.

Alternatively, the computer readable storage medium may be applied to the mobile terminal/terminal device in the embodiments of the present disclosure, and the computer program causes the computer to perform the corresponding processes implemented by the mobile terminal/terminal device in various methods of the embodiments of the present disclosure, which will not be described herein for the sake of brevity.

Embodiments of the present disclosure further provide a computer program product including computer program instructions.

Alternatively, the computer program product may be applied to the network device in the embodiments of the present disclosure, and the computer program instructions cause the computer to execute the corresponding processes implemented by the network device in various methods of the embodiments of the present disclosure, which will not be described herein for the sake of brevity.

Alternatively, the computer program product may be applied to the mobile terminal/terminal device in the embodiments of the present disclosure, and the computer program instruction causes the computer to execute the corresponding processes implemented by the mobile terminal/terminal device in various methods of the embodiments of the present disclosure, which will not be described herein for the sake of brevity.

Embodiments of the present disclosure further provide a computer program.

Alternatively, the computer program may be applied to the network device in the embodiments of the present disclosure, and when the computer program is executed on the computer, the computer executes the corresponding processes implemented by the network device in various methods of the embodiments of the present disclosure, which will not be described herein for the sake of brevity.

Alternatively, the computer program may be applied to the mobile terminal/terminal device in the embodiments of the present disclosure, and when the computer program is executed on the computer, the computer executes the corresponding processes implemented by the mobile terminal/terminal device in various methods of the embodiments of the present disclosure, which will not be described herein for the sake of brevity.

Those of ordinary skill in the art will appreciate that the various exemplary units and algorithm steps described in combination with the embodiments disclosed herein may be implemented in electronic hardware or a combination of computer software and electronic hardware. Whether these functions are performed in hardware or software depends on the specific application and design constraints of the technical solutions. Professionals may use different methods for each particular application to implement the described functionality, but such implementation should not be considered outside the scope of the present disclosure.

Those skilled in the art will clearly appreciate that, for convenience and conciseness of description, the specific operating processes of the above described systems, apparatuses and units may refer to the corresponding processes in the aforementioned method embodiments, which will not be described herein for the sake of brevity.

In several embodiments provided herein, it should be understood that the disclosed systems, apparatuses and methods may be implemented in other ways. For example, the above embodiments of the apparatuses are only schematic, for example, the division of the units is only a logical function division, and in practice, there may be another division mode, for example, multiple units or components may be combined or integrated into another system, or some features may be ignored or not performed. On the other hand, the coupling, direct coupling or communication connection between each other shown or discussed may be indirect coupling or communication connection through some interfaces, apparatus or units, and may be electrical, mechanical or other form.

The units illustrated as separate components may or may not be physically separated, and the components displayed as units may or may not be physical units, i.e., may be located in one place, or may be distributed over multiple network units. Part or all of the units may be selected according to the actual needs to achieve the purpose of the embodiments.

In addition, various functional units in various embodiments of the present disclosure may be integrated in one processing unit, each unit may exist physically alone, or two or more units may be integrated in one unit.

When implemented in the form of software functional units, and sold or used as stand-alone products, the functions may be stored in a computer readable storage medium. With this understanding, the technical solution of the present disclosure in essence or in part contributing to the prior art may be embodied in the form of a software product. The computer software product is stored in a storage medium, and includes instructions for causing a computer device (which may be a personal computer, a server, a network device, etc.) to perform all or part of the steps of the methods described in various embodiments of the present disclosure. The above storage medium includes a U disk, a removable hard disk, a ROM, a RAM, a magnetic disk or an optical disk and other medium capable of storing program codes.

The above is only the specific embodiments of the present disclosure, but the scope of protection of the present disclosure is not limited thereto. Any technical person familiar with the technical field can easily think of changes or substitutions within the technical scope disclosed in the present disclosure, which should be covered within the scope of protection of the present disclosure. Therefore, the scope of protection of the present disclosure shall be subject to the scope of protection of the claims.

1. A communication processing method, comprising:
receiving, by a terminal device, first information related to cell access of Reduced capability User Equipment (RedCap UE),
wherein the RedCap UE refers to a terminal device that supports a maximum bandwidth of less than 20 MHz.

2. The method of claim 1, wherein the first information is used to indicate at least one of:
whether the RedCap UE is prohibited from accessing a first cell;
whether the RedCap UE is allowed to perform intra frequency cell reselection; or
at least one piece of second information, wherein the at least one piece of second information corresponds to at least one frequency point, and each piece of second information is used to indicate whether the RedCap UE is allowed to access a frequency point corresponding to the second information.

3. The method of claim 2, wherein the first information comprises multiple pieces of first sub-information, each piece of first sub-information is used to indicate whether UE, which supports a number N of reception links, of the RedCap UE is prohibited from accessing the first cell, N is greater than or equal to 1, and different pieces of first sub-information correspond to different numbers N of reception links.

4. The method of claim 2, wherein the first information comprises second sub-information and/or third sub-information, wherein the second sub-information is used to indicate whether UE, which supports half duplex, of the RedCap UE is prohibited from accessing the first cell, and the third sub-information is used to indicate whether UE, which supports full duplex, of the RedCap UE is prohibited from accessing the first cell.

5. The method of claim 2, wherein the terminal device is the RedCap UE, and the method further comprises any one of:
determining, by the terminal device according to the first information, whether the terminal device is prohibited from accessing the first cell;
determining, by the terminal device according to a number of reception links supported by the terminal device and multiple pieces of first sub-information, whether the terminal device is prohibited from accessing the first cell; or
determining, by the terminal device according to the second sub-information and/or the third sub-information and a duplex capability supported by the terminal device, whether the terminal device is prohibited from accessing the first cell.

6. The method of claim 2, further comprising:
determining, by the terminal device, that the RedCap UE is prohibited from accessing the first cell in a case that a target parameter is not configured in the first information, wherein the target parameter is a parameter indicating whether the RedCap UE is allowed to perform the intra frequency cell reselection.

7. The method of claim 2, further comprising:
receiving, by the terminal device, cell access prohibition information,
wherein the cell access prohibition information is used to indicate, together with the first information, whether the RedCap UE is prohibited from accessing the first cell, or
the cell access prohibition information is used to indicate, together with multiple pieces of first sub-information, whether the RedCap UE is prohibited from accessing the first cell, or
the cell access prohibition information is used to indicate, together with second sub-information and/or third sub-information, whether the RedCap UE is prohibited from accessing the first cell.

8. The method of claim 7, wherein the terminal device is the RedCap UE, and the method further comprises:
in a case that the cell access prohibition information indicates that the terminal device is prohibited from accessing the first cell, determining, by the terminal device, that the terminal device is prohibited from accessing the first cell;
in a case that the cell access prohibition information indicates that the terminal device is not prohibited from accessing the first cell, performing, by the terminal device, any one of:
determining, by the terminal device according to the first information, whether the terminal device is prohibited from accessing the first cell;
determining, by the terminal device according to a number of reception links supported by the terminal device and the multiple pieces of first sub-information, whether the terminal device is prohibited from accessing the first cell; or
determining, by the terminal device according to the second sub-information and/or the third sub-information and a duplex capability supported by the terminal device, whether the terminal device is prohibited from accessing the first cell.

9. The method of claim 5, wherein determining, by the terminal device according to the number of reception links supported by the terminal device and the multiple pieces of first sub-information, whether the terminal device is prohibited from accessing the first cell comprises:
determining target first sub-information, wherein a number N of reception links corresponding to the target first sub-information is same as the number of reception links supported by the terminal device; and
if the target first sub-information indicates that the RedCap UE is prohibited from accessing the first cell, determining, by the terminal device, that the terminal device is prohibited from accessing the first cell;
if the target first sub-information indicates that the RedCap UE is not prohibited from accessing the first cell, determining, by the terminal device, that the terminal device is allowed to access the first cell.

10. The method of claim 2, wherein the terminal device is the RedCap UE, and the method further comprises:
taking, by the terminal device based on the at least one piece of second information, a frequency point to which the RedCap UE is allowed to be accessed as a candidate frequency point for cell reselection.

11. The method of claim 1, wherein a baseband bandwidth supported by the RedCap UE is less than or equal to 5 MHz; or
a maximum baseband bandwidth supported by a physical shared channel of the RedCap UE is less than or equal to 5 MHz.

12. A terminal device, comprising a processor and a memory, wherein the memory is configured to store a computer program, and the processor is configured to invoke and execute the computer program stored in the memory to perform an operation of:
receiving, by a terminal device, first information related to cell access of Reduced capability User Equipment (RedCap UE),
wherein the RedCap UE refers to a terminal device that supports a maximum bandwidth of less than 20 MHz.

13. The terminal device of claim 12, wherein the first information is used to indicate at least one of:
whether the RedCap UE is prohibited from accessing a first cell;
whether the RedCap UE is allowed to perform intra frequency cell reselection; or
at least one piece of second information, wherein the at least one piece of second information corresponds to at least one frequency point, and each piece of second information is used to indicate whether the RedCap UE is allowed to access a frequency point corresponding to the second information.

14. The terminal device of claim 13, wherein the first information comprises multiple pieces of first sub-information, each piece of first sub-information is used to indicate whether UE, which supports a number N of reception links, of the RedCap UE is prohibited from accessing the first cell, N is greater than or equal to 1, and different pieces of first sub-information correspond to different numbers N of reception links,
or wherein the first information comprises second sub-information and/or third sub-information, wherein the second sub-information is used to indicate whether UE, which supports half duplex, of the RedCap UE is prohibited from accessing the first cell, and the third sub-information is used to indicate whether UE, which supports full duplex, of the RedCap UE is prohibited from accessing the first cell.

15. The terminal device of claim 13, wherein the terminal device is the RedCap UE, and the processor is further configured to invoke and execute the computer program stored in the memory to perform operations of:
determining, by the terminal device according to the first information, whether the terminal device is prohibited from accessing the first cell;
determining, by the terminal device according to a number of reception links supported by the terminal device and multiple pieces of first sub-information, whether the terminal device is prohibited from accessing the first cell; or
determining, by the terminal device according to the second sub-information and/or the third sub-information and a duplex capability supported by the terminal device, whether the terminal device is prohibited from accessing the first cell.

16. A network device, comprising a processor and a memory, wherein the memory is configured to store a computer program, and the processor is configured to invoke and execute the computer program stored in the memory to perform an operation of:
transmitting, a network device, first information related to cell access of Reduced capability User Equipment (RedCap UE),
wherein the RedCap UE refers to a terminal device that supports a maximum bandwidth of less than 20 MHz.

17. The network device of claim 16, wherein the first information is used to indicate at least one of:
whether the RedCap UE is prohibited from accessing a first cell;
whether the RedCap UE is allowed to perform intra frequency cell reselection; or
at least one piece of second information, wherein the at least one piece of second information corresponds to at least one frequency point, and each piece of second information is used to indicate whether the RedCap UE is allowed to access a frequency point corresponding to the second information.

18. The network device of claim 17, wherein the first information comprises multiple pieces of first sub-information, each piece of first sub-information is used to indicate whether UE, which supports a number N of reception links, of the RedCap UE is prohibited from accessing the first cell, N is greater than or equal to 1, and different pieces of first sub-information correspond to different numbers N of reception links,
or wherein the first information comprises second sub-information and/or third sub-information, wherein the second sub-information is used to indicate whether UE, which supports half duplex, of the RedCap UE is prohibited from accessing the first cell, and the third sub-information is used to indicate whether UE, which supports full duplex, of the RedCap UE is prohibited from accessing the first cell.

19. The network device of claim 17, wherein in a case that a target parameter is not configured in the first information, the first information is further used to indicate that the RedCap UE is prohibited from accessing the first cell, wherein the target parameter is a parameter indicating whether the RedCap UE is allowed to perform the intra frequency cell reselection.

20. The network device of claim 17, wherein the processor is further configured to invoke and execute the computer program stored in the memory to perform operations of:
transmitting, by the network device, cell access prohibition information,
wherein the cell access prohibition information is used to indicate, together with the first information, whether the RedCap UE is prohibited from accessing the first cell, or
the cell access prohibition information is used to indicate, together with multiple pieces of first sub-information, whether the RedCap UE is prohibited from accessing the first cell, or
the cell access prohibition information is used to indicate, together with second sub-information and/or third sub-information, whether the RedCap UE is prohibited from accessing the first cell,
wherein the processor is further configured to invoke and execute the computer program stored in the memory to perform operations of:
transmitting, by the network device, multiple pieces of third information, wherein each piece of third information is used to indicate whether UE, which supports a number M of reception links, of target UE is prohibited from accessing the first cell, M is greater than or equal to 1, and different pieces of third information correspond to different numbers M of reception links, wherein the target UE refers to UE that supports a maximum bandwidth of less than or equal to 20 MHZ,
wherein the multiple pieces of third information are used to indicate, together with the cell access prohibition information and any one of the first information, the multiple pieces of first sub-information, the second sub-information, or the third sub-information, whether the RedCap UE is prohibited from accessing the first cell.
